(19) United States
(12) Patent Application Publication
(10) Pub. No.: US 2022/0404289 A1
(43) Pub. Date: Dec. 22, 2022

(54) A METHOD AND APPARATUS FOR INSPECTING A LIGHT CONTROL LAYER FOR A SECURITY DEVICE

(71) Applicant: DE LA RUE INTERNATIONAL LIMITED, Basingstoke, Hampshire (GB)

(72) Inventor: John GODFREY, Basingstoke (GB)

(73) Assignee: DE LA RUE INTERNATIONAL LIMITED, Basingstoke, Hampshire (GB)

(21) Appl. No.: 17/638,482

(22) PCT Filed: Oct. 9, 2020
(86) PCT No.: PCT/GB2020/052520

§ 371 Date: Feb. 25, 2022

(30) Foreign Application Priority Data
Oct. 11, 2019 (GB) 1914760.2

(51) Int. Cl. G01N 21/86; B42D 25/351; B42D 25/324

(52) U.S. Cl. CPC G01N 21/86; B42D 25/351; B42D 25/324; G01N 2201/06113; G07D 7/12

(57) ABSTRACT

A method of inspecting a substantially transparent light control layer for an optically variable security device and a corresponding inspection apparatus, the substantially transparent light control layer including a surface relief defined by an array of substantially transparent refractive microstructures. The method includes: directing a beam of substantially collimated light towards a first region that is expected to contain the surface relief of the light control layer so as to generate an inspection light pattern; providing reference data that is indicative of a light control layer that meets a predetermined quality threshold; comparing the inspection light pattern with the reference data; and determining whether the light control layer meets the predetermined quality threshold based on the comparison.

### BACKGROUND TO THE INVENTION

To prevent counterfeiting and to enable authenticity to be checked, security documents are typically provided with one or more security devices; by which we mean a feature that is not possible to reproduce accurately by taking a visible light copy, e.g. through the use of standardly available photocopying or scanning equipment.

Examples include features based on one or more patterns such as microtext, fine line patterns, latent images, venetian blind devices, lenticular devices, moire interference devices and moire magnification devices, each of which generates a secure visual effect. Other known security devices include holograms, watermarks, embossings, perforations and the use of colour-shifting or luminescent/fluorescent inks. Common to all such devices is that the visual effect exhibited by the device is extremely difficult, or impossible, to copy using available reproduction techniques such as photocopying. Security devices exhibiting non-visible effects such as magnetic materials may also be employed.

One class of security devices are those which produce an optically variable effect, meaning that the appearance of the device is different at different angles of view. Such “optically variable” security devices are particularly effective since direct copies (e.g. photocopies) will not produce the optically variable effect and hence can be readily distinguished from genuine devices. Optically variable effects can be generated based on various different mechanisms, including holograms and other diffractive devices, colour-shifting materials, moire interference and other mechanisms relying on parallax such as venetian blind devices, and also devices which make use of focussing elements such as lenses, including moire magnifier devices, integral imaging devices and so-called lenticular devices.

Optically variable security devices that make use of refractive microstructures (e.g. microlenses or microprisms) are typically formed using an embossing process. A layer of resin is embossed with a casting tool carrying a surface relief defining the shape of the desired structure(s) that is to be cast into the resin. Typically, the resin is a curable resin which is cured during the embossing, for example with UV radiation. This is conventionally known as “cast curing”. For efficiency, this cast curing process is generally performed as part of a web-based or sheet-based process, as is known in the art.

Another embossing process that is conventionally employed to form microstructures is a so-called “hot emboss” process. Here, a substrate that is either thermally deformable (or carrying a layer that is thermally deformable) is heated and embossed with a casting tool to generate the desired structures.

However, problems do occur during such embossing processes, leading to structures of poor quality that detract from the desired optically variable effect (and consequently reducing the security level of the device). Problems include air bubbles forming in the resin during the casting process; contamination of the casting tool (e.g. dirt accumulating therein); incorrect peeling of the resin off the casting tool thus damaging the structures; partial peeling leaving resin in the casting tool; misregistration (including skew and x,y positional registration problems), wear and damage of the casting tool, and inadequate curing amongst others.

It is therefore desirable to check the quality of the cast structures. However, this is difficult due to the typically optically transparent nature of the microstructures, especially those that are based on refractive effects. Current methods of inspecting such microstructures include non-destructive examination through use of a microscope to identify microscopic defects, 3(d) inspection via a profiling kit such as confocal or white light interferometry, as well as simple visual checks to identify macro issues such as misregistration or pinholes; or destructive examination through use of a SEM. However, these methods are generally performed “off-line”, for example by testing a sample sheet in a sheet-based process. This is inefficient and can lead to increased waste.

It is therefore desirable to improve the inspection of such structures.

### SUMMARY OF THE INVENTION

In accordance with a first aspect of the invention there is provided method of inspecting a substantially transparent light control layer for an optically variable security device, said substantially transparent light control layer comprising a surface relief defined by an array of substantially transparent refractive microstructures, the method comprising: directing a beam of substantially collimated light towards a first region that is expected to contain the surface relief of the light control layer so as to generate an inspection light pattern; providing reference data that is indicative of a light control layer that meets a predetermined quality threshold; comparing the inspection light pattern with the reference data; and determining whether the light control layer meets the predetermined quality threshold based on the comparison.

The inventors have found that when illuminated by a beam of substantially collimated light, the surface relief of such a substantially transparent light control layer interacts with the incident light to generate an inspection light pattern in the transmitted beam. The inspection light pattern may then be compared to reference data indicative of a light control layer that meets a predetermined quality threshold and in this way it can be determined, using said comparison, whether or not the light control layer meets the predetermined quality threshold.

This advantageously provides an efficient way of inspecting such light control layers comprising refractive microstructures as compared to conventional techniques which may need to be performed off-line, as described above.

In particular, the formation of an inspection light pattern due to the interaction of the light beam with the refractive microstructures of the light control layer provides an efficient way of inspecting such light control layers as compared to conventional techniques.

The light control layer comprises an array of substantially transparent refractive microstructures that define a surface relief of the light control layer. The microstructures are refractive in the sense that the desired optically variable effect generated by the microstructures for the optically variable security device is based predominantly on the refraction of light. Thus, such refractive microstructures typically have a size (e.g. pitch and height) greater than 2 microns such that diffractive effects in the desired optically variable effect for the security device are negligible.

In embodiments the array of refractive microstructures comprises an array of focussing elements, preferably microlenses. Such focussing elements typically have a pitch (e.g. pitch of the surface relief) in the range of 5 to 150 microns, preferably 20 to 80 microns; a height of 5 to 50 microns, preferably 5 to 30 microns; and a focal length of 5 to 100 microns, preferably 5 to 80 microns.

The array of refractive microstructures may comprise an array of microprisms, preferably linear microprisms. Such an array of microprisms typically has a pitch (e.g. pitch of the surface relief) in the range of 2-100 microns, preferably 5-70 microns; and a structure depth in the range of 2-100 microns, more preferably 5-40 microns.

The method of the present invention finds particular benefit in web-based or sheet-based methods of manufacturing security articles (e.g. security threads or foils) or security documents (e.g. banknotes, ID cards, passports) having security devices formed thereon or integrated therein, with said security devices comprising light control layers. This is because the beam of substantially collimated light may be directed towards the light control layers of the security devices as they are conveyed along the web-based or sheet-based machine (“press”), generating an inspection light pattern that may be used to determine the quality of the light control layers. Preferably therefore, the light control layer is located on a web or a sheet, and the method further comprises conveying the web or sheet in a machine direction, wherein the beam of substantially collimated light is directed towards the first region as the web or sheet is conveyed in the machine direction.

Preferably, the light control layer is located on a substantially transparent area of a web or a sheet and the method further comprises conveying the web or sheet in a machine direction, wherein the beam of substantially collimated light is directed towards the first region as the web or sheet is conveyed in the machine direction. The substantially transparent area of the web or sheet is typically a window region of a security article or document such that the beam may be transmitted through the light control layer and the web or sheet to form the inspection light pattern.

In embodiments, the inspected light control layer may be part of a security device. For example, the light control layer may comprise an array of focussing elements such as microlenses that cooperate with an image layer in order to exhibit an optically variable effect (e.g. a lenticular effect). In another example the light control layer may comprise an array of prismatic structures that cooperate with a colour shifting layer in order to exhibit an optically variable effect. In embodiments where the inspected light control layer is part of a security device, the security device is typically located in a substantially transparent window region of a security article or document such that the beam of substantially collimated light may pass through the security device in order to form the inspection light pattern.

It is to be noted that in cases where the beam of substantially collimated light passes through further layers in addition to the light control layer (e.g. where the light control layer is part of a security device) in order to form the inspection light pattern in transmission, the inspection light pattern is generated primarily due to the interaction of the beam with the microstructures of the light control layer.

The inspection of the light control layers may occur at a time in the manufacturing process before opaque layers (e.g. opacifying layers) have been applied to the security article or document.

An inspection light pattern may be generated in reflection (e.g. due to reflection of the incident beam at the surface of the light control layer). Typically, an inspection light pattern generated in transmission will have a greater intensity than an inspection light pattern generated in reflection, and so the inspection light pattern generated in transmission will generally be used for the comparison with the reference data and determination of whether the light control layer meets the predetermined quality threshold.

The method of the present invention is primarily directed to inspection of light control layers for quality control purposes during manufacture of security devices. For example it is envisaged that the inventive method may be employed during web-based or sheet-based processes for manufacturing articles or documents having a security device (containing a light control layer) integrated therein during the manufacture. However, in embodiments, the method may be used for quality control after manufacture, for example in single banknote inspection after the banknote production is fully complete (i.e. after all of the print workings have been applied and the notes have been cut to size). Currently, in post-manufacture single banknote inspection, the quality check is based on the presence or absence of a “macro” security device rather than the quality of the formed light control layer. Thus, the present invention which allows for determining whether or not the light control layer meets a predetermined quality threshold may be particularly advantageous in such post-manufacturing inspection.

The method of the present invention is typically performed in a web-based or sheet-based process for manufacturing security documents or security articles having security devices located thereon or therein, wherein said security devices comprise a transparent light control layer. The light control layers of the security documents or articles comprise a surface relief defined by an array of substantially transparent refractive microstructures as described above. By comparing the generated inspection light pattern with the reference data during the web-based or sheet-based manufacturing process, a high level of quality control inspection of refraction-based security devices may be achieved whilst maintaining fast operating speeds during manufacture. Examples of security articles include a security thread, strip, foil, insert, label, patch or a substrate for a security document. Examples of security documents include a banknote, cheque, passport, identity card, certificate of authenticity, fiscal stamp of other document for securing value or personal identify.

In embodiments the method may comprise determining the authenticity of a security device based on whether the light control layer meets the predetermined quality threshold. For example, typically if the light control layer meets the predetermined quality threshold then it can be inferred that the device is authentic. The method therefore provides a straightforward and readily repeatable means of determining the authenticity of a security device. By determining the authenticity of the device using the present method, the authenticity of the article or document carrying the device may be determined.

In other embodiments, the light control layer does not form part of a security device. Such a light control layer may be referred to as a “test” light control layer. Thus, the method may be used to inspect a test light control layer in order to determine the quality of the process (e.g. embossing) used to form the test light control layer, from which the quality of other structures formed by that process may be inferred. For example, in embodiments, the light control layer (being inspected) is formed by a first process (e.g. embossing), and at least one security device comprises a light control layer formed by said first process (e.g. embossing). Typically the “test” light control layer and the light control layers of the final security devices are formed from a common (same) embossing tool.

Thus, from the results of the inspection it can be inferred whether or not the light control layers of the security devices themselves meet the predetermined quality threshold without having to inspect each individual light control layer of the security devices. This may advantageously allow for faster running speeds during manufacture.

The test light control layer may have substantially the same form (e.g. size, surface relief) as a light control layer forming part of a security device. In other words, the test light control layer being inspected may be considered to be a “replica” of the light control layer forming part of a security device, and from which the quality of the light control layer of the security device may be inferred. Typically, a test light control layer is produced during the same manufacturing process as a plurality of security devices, with the test light control layer being laterally spaced from the security devices (e.g. on a web or sheet). For example, in a web-based or sheet-based process for manufacturing banknotes that comprise a security device having a light control layer, a “test” light control layer may be produced laterally spaced from the banknotes (e.g. on the side edges of the sheet or web). The test light control layer may then be inspected and from the results of the inspection the quality of the light control layers on the banknotes may be inferred. Such a test light control layer may be produced as a continuous structure or at a predetermined repeat distance in a web-based process, and produced on every sheet in a sheet-based process for example. This advantageously allows for fast manufacturing speeds. The test light control layer may subsequently be discarded.

In some embodiments, a “test” light control layer may be located on or integrated within the security document or security article itself. In such cases, the test light control layer preferably does not cooperate with an effect-generating layer (e.g. image layer or colour shifting layer).

In embodiments the test light control layer may have a different form to a light control layer forming part of a security device. This may be advantageous in the case where the light control layer forming part of a security device has a complex form (e.g. multi-orientation, pitch or structure geometry), meaning that the inspection light pattern is complex and difficult to compare with reference data. In such a case the test light control layer may have a simpler (less complex) form such that the inspection light pattern is less complex and consequently comparison with the reference data is more straightforward. In a second case, the light control layer of the security device may have a very simple form, giving rise to a correspondingly simple inspection light pattern (e.g. having a single orientation). This may not contain sufficient information to infer the quality of the manufacturing process (e.g. along both a machine direction and a cross direction) and thus the test light control layer may take a more complex form in order to provide an inspection light pattern containing sufficient information for quality threshold determination.

The method of the present invention comprises providing reference data that is indicative of a light control layer that meets a predetermined quality threshold and comparing the inspection light pattern with the reference data. In embodiments, the reference data comprises a reference value of a predetermined metric and the comparing step comprises detecting an inspection value of the predetermined metric from the inspection light pattern, and comparing the inspection value with the reference value. The use of quantitative reference and inspection values in this way advantageously allows for a repeatable determination as to whether inspected light control layers meet the predetermined quality threshold.

The predetermined metric may be any of: (i) a number of elements in the inspection light pattern; (ii) a resolution of the inspection light pattern; (iii) an intensity of the inspection light pattern; (iv) an orientation of the inspection light pattern; (v) a pitch of the inspection light pattern. It will be appreciated that in comparing the inspection light pattern with the reference data, the values of more than one predetermined metric may be used. The reference value(s) of the predetermined metric(s) may be calculated based on known parameters of the beam of substantially collimated light and the light control layer being inspected. Alternatively or in addition, the reference value(s) may be obtained from a reference light pattern. Such a reference light pattern may be obtained by directing a beam of substantially collimated light towards a reference light control layer that is known to meet the predetermined quality threshold.

The predetermined metric may be a number of elements in the inspection light pattern. Typically the inspection light pattern (and the reference light pattern, where used) is in the form of a spot pattern. If a beam of collimated light is directed towards a transparent planar sheet of material (i.e. no surface relief), then the resulting light pattern would be in the form of a single spot when the beam is incident on a viewing screen (e.g. a white piece of card) after transmission through the sheet of material. The inventors have found that when a beam of collimated light having a diameter greater than a pitch of a surface relief (e.g. a pitch of the refractive microstructures forming the surface relief) interacts with the surface relief, it an inspection light pattern is produced that comprises a plurality of spots. Thus, the presence of two or more elements (e.g. spots) in the inspection light pattern is indicative of the presence of a light control layer. Such a metric may be used to determine lateral (x,y) registration quality of the light control layer, for example.

The predetermined metric may be a resolution of the inspection light pattern (e.g. number of elements per unit length or the size of the elements of the pattern). Typically, a light control layer that has been well formed produces an inspection light pattern having well defined elements (e.g. spots) when a beam of collimated light is incident upon it. Thus, a high resolution of the inspection light pattern may be indicative of a good quality light control layer. In particular this may be indicative of the surface relief of the light having been formed correctly.

The predetermined metric may be an intensity (e.g. brightness) of the inspection light pattern. This may be indicative of the optical properties (e.g. transparency) of the curable material forming the light control layer. The intensity of the entire inspection light pattern (e.g. the combined intensity of each element in the pattern) may be used in the comparison as well as the intensity of each individual element. For example, an analysis of the intensity of the entire inspection light pattern may reveal problems with the bulk material forming the light control layers (e.g. the material not being transparent enough, or having contaminants/air bubbles causing scattering in the structure reducing intensity of the light pattern), and analysis of individual elements may be indicative of quality control problems in specific areas.

The predetermined metric may be an orientation of the inspection light pattern. The orientation of the inspection light pattern may be defined relative to a known direction, for example. The orientation of the inspection light pattern is indicative of the skew of the light control layer relative to the substrate (e.g. web or sheet) on which it is formed.

The predetermined metric may be a pitch of the inspection light pattern (e.g. a distance between adjacent elements in the pattern). The pitch of the inspection light pattern may be useful to infer a pitch of the light control layer (e.g. the distance between adjacent microstructures forming the surface relief), and regularity of the pitch may be used to infer any areas of the light control layer where microstructures have been formed incorrectly, for example.

The reference value of the one or more predetermined metrics may be in the form of a single value. The light control layer may be deemed to meet the predetermined quality threshold if the detected value for that metric exceeds (or is equal to or exceeds) the reference value. In other cases the light control layer may be deemed to meet the predetermined quality threshold if the detected value for that metric is less than (or is equal to or is less than) the reference value, as appropriate for the metric.

The reference value for the one of more predetermined metrics may be in the form of a range for values. The light control layer may be deemed to meet the quality threshold if the inspection value falls within the range, or alternatively falls outside of the range, as appropriate for the metric.

The values or ranges of the reference values may be chosen dependent on the desired tolerance of the quality of the light control layers being inspected.

It will also be appreciated that the quantitative comparison of the inspection values with the reference values may be used to diagnose problems with the process forming the light control layer, as well as to determine whether or not the light control layers meet the predetermined quality threshold.

The reference data may be in the form of a reference light pattern. This may be used for visual comparison (e.g. by an operator) of the inspection light pattern with the reference light pattern in order to determine whether or not the light control layer meets the predetermined quality threshold. Such a reference light pattern may be obtained by directing a beam of substantially collimated light towards a reference light control layer that is known to meet the predetermined quality threshold. Alternatively, the reference light pattern may be calculated based on known parameters of the beam of substantially collimated light and the light control layer being inspected.

In embodiments where the light control layer is located on a web or a sheet, if it is determined that the light control layer does not meet the predetermined quality threshold, the method may further comprise at least one of: marking the web or sheet to indicate that the light control layer did not meet the predetermined quality threshold; noting the location on the web or sheet of the light control layer that did not meet the predetermined quality threshold; and stopping conveying the web or sheet along the machine direction. By marking the web or sheet, or noting the location of the light control layer(s) that did not meet the predetermined quality threshold, those areas of the web or sheet may be subsequently discarded. For example, a sheet of banknotes having light control layers that did not meet the predetermined quality threshold may be subsequently directed to a reject pile separate to “good” sheets. In some embodiments the manufacturing process may be stopped in order to correct the problem. In some cases it may be possible to correct the issue causing the light control layers to not meet the predetermined quality threshold while the web or sheet continues to be conveyed along the machine direction. Such features of the present invention allow efficient quality control of refraction-based light control layers during the manufacturing process.

As has been discussed, the method of the present invention comprises directing a beam of substantially collimated light towards a first region that is expected to contain the surface relief of the light control layer. By substantially collimated we mean that the beam does not significantly diverge over long distances. The distance between the light source and the light control layer is typically 5mm to 1000mm, preferably 10mm to 100mm. Preferably, the beam has a diameter at the first region that is greater than a pitch of the surface relief. In other words, the beam has a “spot size” when impinging on the surface relief that is greater than a pitch of the surface relief. Typically the beam has a circular cross section, although this is not essential and other cross-sectional geometries such as square or rectangular are envisaged. As the diameter of the beam at the first region is greater than a pitch of the surface relief (e.g. the beam passes through multiple refractive microstructures forming the surface relief), the inspection light pattern when a light control layer is present is in the form of a spot pattern comprising a plurality of spots.

In preferred embodiments the beam of substantially collimated light is substantially coherent. By coherent we mean that the photons within the beam have a defined phase relationship. In preferred embodiments, the beam of substantially collimated light is substantially monochromatic. By monochromatic we mean that the beam is a substantially single wavelength within the visible part of the electromagnetic spectrum, thus producing a single spectral colour. Monochromatic light advantageously means that the light pattern is more clearly defined as the beam is not refracted by the surface relief into its constituent colours. However, it is envisaged that a multi-coloured inspection light pattern could be used to further aid the comparison of the inspection light pattern with the reference data, for example the arrangement of the colours of such a multi-coloured inspection light pattern could be used as a predetermined metric for comparison. Alternatively, a collimated broadband source could be used with an optical filter used to filter out unwanted spectral components.

The beam of substantially collimated light is preferably provided by a laser source. A typical power of the laser source is in the range of 1 mW to 20 mW, preferably 1 mW to 5 mW. The beam of substantially collimated light typically has a diameter at the first region of between 50 microns and 10 millimetres, preferably between 500 microns and 5 millimetres. The pitch of the surface relief of a light control layer being inspected is typically in the range of 2 to 100 microns. The diameter of the beam of substantially collimated light is chosen so as to cover (e.g. overlaps with) a plurality of individual microstructures forming the surface relief of the light control layer so as to form the inspection light pattern. The diameter of the beam may be adjusted in order to cover (and thus inspect) different numbers of microstructures of a light control layer at a particular time instance. In other words, by adjusting the dimeter of the beam at the first region, different numbers of refractive microstructures may contribute to the inspection light pattern.

In other embodiments, uncollimated light from a light source (e.g. lamp) may be passed through a collimator to produce the beam of substantially collimated light.

The inspection light pattern is generated after transmission of the beam of substantially collimated light through the substantially transparent light control layer.

The inspection light pattern may simply be projected onto a viewing screen (e.g. a piece or white paper). The projected inspection light pattern may then be analysed in order to detect an inspection value of a predetermined metric, or visually compared to a reference pattern as has been discussed above. However, in preferred embodiments, the method further comprises recording the inspection light pattern using an optical sensor. Preferably the inspection light pattern is recorded as an image or sequence or images using a camera (for example recording an image of the viewing screen), although it is envisaged that the inspection light pattern may be recorded directly onto a photosensitive sensor such as a CCD or CMOS detector, for example without the use of a viewing screen or focussing optics such as when using a camera. The recorded inspection light pattern may then be used to determine whether the inspected light control layer meets the predetermined quality threshold as has been explained above. Preferably, the inspection light pattern is projected on an opposing side of the light control layer to the source of the light beam (e.g. a laser).

As has been discussed above, the present invention may be used in web-based or sheet-based manufacturing processes, where the beam of substantially collimated light is directed towards the first region as the web or sheet is conveyed past the beam in the machine direction. Thus, the inspection light pattern may be continuously updated (e.g. continuously change) as the light control layers being inspected move along the machine direction. The optical sensor (e.g. camera) may be configured to record individual discrete inspection light patterns (e.g. individual static images) at fixed time intervals for comparison with the reference data. It is also envisaged that the continually updated inspection light pattern may be recorded as a sequence of images (e.g. “video”) and compared with the reference data.

In general the array of refractive microstructures may be referred to as “one-dimensional” or “two-dimensional”. One-dimensional microstructures typically exhibit an optical effect most strongly when viewed along one axis, with examples including cylindrical microlenses and elongate linear microprisms. Two-dimensional microstructures are less anisotropic and the optical effect is readily seen when viewed along two (or more) axes. Examples of two-dimensional microstructures include spherical microlenses and pyramidal structures.

The light control layer is substantially transparent and is typically formed from a transparent curable material. Herein, the term “transparent” means that visible light may pass through the material without being significantly scattered. Typically, the light control layer is formed by an embossing process such as cast-curing or hot embossing. Suitable (UV) curable materials may comprise a resin which may typically be of one of two types, namely: a) Free radical cure resins, which are typically unsaturated resins or monomers, pre-polymers, oligomers etc. containing vinyl or acrylate unsaturation for example and which cross-link through use of a photo initiator activated by the radiation source employed e.g. UV. b) Cationic cure resins, in which ring opening (e.g. epoxy types) is effected using photo initiators or catalysts which generate ionic entities under the radiation source employed e.g. UV. The ring opening is followed by intermolecular cross-linking.

The radiation used to effect curing is typically UV radiation but could comprise electron beam, visible, or even infra-red or higher wavelength radiation, depending upon the material, its absorbance and the process used. Examples of suitable curable materials include UV curable acrylic based clear embossing lacquers or those based on other compounds such as nitro-cellulose. A suitable UV curable lacquer is the product UVF-203 from Kingfisher Ink Limited or photopolymer NOA61 available from Norland Products. Inc., N.J.

The curable material could be elastomeric and therefore of increased flexibility. An example of a suitable elastomeric curable material is aliphatic urethane acrylate (with suitable cross-linking additive such as polyaziridine).

In an embodiment of the first aspect there is provided a method of inspecting a substantially transparent light control layer for an optically variable security device, said substantially transparent light control layer comprising a surface relief defined by an array of substantially transparent refractive microstructures, the method comprising: directing a beam of substantially collimated light towards a first region that is expected to contain the surface relief of the light control layer so as to generate an inspection light pattern, said beam having a diameter at said first region that is greater than a pitch of the surface relief; providing reference data that is indicative of a light control layer that meets a predetermined quality threshold; comparing the inspection light pattern with the reference data; and determining whether the light control layer meets the predetermined quality threshold based on the comparison.

In accordance with a second aspect of the invention there is provided an inspection apparatus for inspecting a substantially transparent light control layer for an optically variable security device, said substantially transparent light control layer comprising a surface relief defined by an array of substantially transparent refractive microstructures, the inspection apparatus comprising: a light source configured to direct a beam of substantially collimated light towards a first region that is expected to contain the surface relief of the light control layer so as to generate an inspection light pattern; an optical sensor configured to record the inspection light pattern; and a comparison module configured to compare the recording of the inspection light pattern with reference data that is indicative of a light control layer that meets a predetermined quality threshold, and to determine whether the light control layer meets the predetermined quality threshold based on the comparison.

The inspection apparatus therefore provides all of the advantages as have been described above with reference to the first aspect. Preferably, the beam of substantially collimated light has a diameter at said first region that is greater than a pitch of the surface relief.

Typically, the light control layer is located on a (preferably substantially transparent area of a) web or a sheet, and the inspection apparatus is configured to receive the web or sheet on which the light control layer is located, and convey said web or sheet through the apparatus in a machine direction. Thus, similarly to as has been discussed above with reference to the first aspect of the invention, the inspection apparatus has particular benefit when used in a web-based or sheet-based process for manufacturing security articles or documents having security devices located thereon or integrated therein. In embodiments, the apparatus may comprise a marking module configured to mark the web or sheet if it is determined by the comparison module that the light control layer did not meet the predetermined quality threshold. Light control layers not meeting the predetermined quality threshold may subsequently be located and discarded. In this way, the inspection apparatus is particularly suited to quality control of security devices having refractive light control layers during a web-based or sheet-based manufacturing process.

In some embodiments, the inspection apparatus may be used for authentication based on the determined quality of the light control layer. Thus, in embodiments the light control layer is part of a security device, and the comparison module may be further configured to determine the authenticity of the security device based on whether the light control layer meets the predetermined quality threshold.

Preferably, the beam of substantially collimated light is also substantially coherent and/or substantially monochromatic. Typically, the light source is a laser light source. Preferably the beam of substantially collimated light has a diameter at the first region of between 50 microns and 10 millimetres, preferably between 500 microns and 5 millimetres.

The inspection apparatus comprises an optical sensor configured to record the inspection light pattern. Typically the optical sensor comprises a camera and the inspection light pattern is recorded as an image or sequence of images recorded by the camera. In other embodiments the inspection light pattern may be recorded as a sensor reading detected directly by a photosensitive detector such as a CCD or CMOS detector. Typically the light source and the optical sensor are positioned on opposing sides of the light control layer (e.g. on opposing sides of a web or sheet). This is particularly advantageous when the optical sensor comprises a camera since the camera has a direct line of sight to the inspection light pattern, which is projected on the opposing side of the light control layer to the light source. However, other configurations of the light source and optical sensor are envisaged; for example in some embodiments the light source and optical sensor may be positioned on the same side of the light control layer.

Typically, the reference data comprises a reference value of a predetermined metric and the comparison module is configured to compare the recording (e.g.

image) of the inspection light pattern with the reference data by: detecting an inspection value of the predetermined metric from the image of the inspection light pattern, and comparing the inspection value with the reference value. The predetermined metric may be any of: (i) a number of elements in the inspection light pattern; (ii) a resolution of the inspection light pattern; (iii) an intensity of the inspection light pattern; (iv) an orientation of the inspection light pattern; (v) a pitch of the inspection light pattern, as described above with reference to the first aspect of the invention.

In an embodiment of the second aspect there is provided an inspection apparatus for inspecting a substantially transparent light control layer for an optically variable security device, said substantially transparent light control layer comprising a surface relief defined by an array of substantially transparent refractive microstructures, the inspection apparatus comprising: a light source configured to direct a beam of substantially collimated light towards a first region that is expected to contain the surface relief of the light control layer so as to generate an inspection light pattern, said beam having a diameter at said first region that is greater than a pitch of the surface relief; an optical sensor configured to record the inspection light pattern; and a comparison module configured to compare the recording of the inspection light pattern with reference data that is indicative of a light control layer that meets a predetermined quality threshold, and to determine whether the light control layer meets the predetermined quality threshold based on the comparison.

Also disclosed herein is a web-based or sheet-based press for manufacturing security articles or security documents, comprising an inspection apparatus according to the second aspect of the invention, or adapted to perform the method of the first aspect of the invention. Such a press is typically configured for manufacturing security articles (e.g. security threads, security foils and the like) or security documents (e.g. banknotes, identity cards, passports and the like) with a security device comprising a light control layer formed therein or thereon. Such security devices typically comprise a refractive light control layer and an effect-generating layer positioned for optical cooperation with the light control layer in order that the security device exhibits an optically variable effect. The inspection apparatus and method of the present invention advantageously allows quality control inspection of the light control layer as part of the manufacturing process. The inspection apparatus is positioned within the press downstream from the formation of the light control layer.

Typically such a web-based or sheet-based printing press is an in-line printing press.

Further disclosed herein is a security document or security article comprising: a transparent (e.g. polymer) substrate carrying opacifying layers on opposing surfaces thereof so as to define a window region; wherein within the window region the document or article comprises: an effect generating region comprising one or more effect generating elements; an inspection region laterally offset from the effect generating region, wherein the inspection region is free of any effect generating elements; and a substantially transparent light control layer comprising a surface relief defined by an array of substantially transparent refractive microstructures, said light control layer overlapping with both the effect generating region and the inspection region, and wherein the substantially transparent light control later cooperates with the effect generating region to exhibit an optically variable effect.

The region of the light control layer that overlaps with the inspection region advantageously forms a “test” light control layer (or test region of the light control layer) that may be inspected, typically for quality control purposes during manufacture of the document or article. Typically, the light control layer of such a document or article may be inspected during its manufacture in a sheet-based or web-based process using the method and apparatus of the present invention.

The window region may be a “full” window region in which the light control layer is visible from both sides of the substrate (the opacifying layers on both surfaces of the substrate comprise apertures in register). The window region may be a “half” window region in which the light control layer is visible from one side of the substrate only (the opacifying layer on only one surface of the substrate comprises an aperture). The window region may comprise combination of a “full” window and a “half” window.

In preferred embodiments, the inspection region has a dimension of greater than 3 millimetres and less than 10 millimetres, preferably between 3.5 millimetres and 5 millimetres.

Preferably, the substantially transparent light control layer is in the form of an array of focussing elements defining a focal plane, and the effect generating region (e.g. effect generating layer) comprises an array of image elements, and is located within a plane substantially coincident with the focal plane of the focussing elements. In such embodiments, the array of focussing elements (e.g.

lenses) and array of image elements form a security device that exhibits an optically variable effect such as a lenticular or moire effect. Alternative light control layers and effect generating regions may be used however. For example, the light control layer may be in the form of refractive microprisms, and the effect generating region may comprise an effect generating element in the form of a colour shifting layer.

Typically, the light control layer will be provided on one surface of the transparent substrate and the effect generating region and inspection region will both be provided on the opposing surface of the transparent substrate.

Particularly preferably, the security document or security article is a security document in the form of a banknote.

Further disclosed is a web or sheet (e.g. for web-based or sheet-based printing processes) comprising a plurality of security documents or security articles as described above.

### BRIEF DESCRIPTION OF THE DRAWINGS

Preferred embodiments of the invention will be described with reference to the attached drawings, in which:

FIG. 1(a) is a cross-sectional view of a banknote having a security device integrated therein;

FIG. 1(b) schematically depicts a method of cast-curing a light control layer;

FIG. 2 is a flow diagram outlining the main steps of a preferred embodiment of inspecting a light control layer;

FIGS. 3(a) to 3(e) schematically illustrate inspection modules according to embodiments of the invention;

FIGS. 4(a) and 4(b) are top-down images of light control layers;

FIG. 5(a) is an example of a reference light pattern;

FIG. 5(b) is an example of an inspection light pattern;

FIG. 6 schematically illustrates how the present invention may be used to detect miss-registration issues;

FIGS. 7(a) and 7(b) illustrate inspection of the orientation of a light control layer;

FIGS. 8 to 10 schematically illustrate printing presses incorporating inspection modules according to embodiments of the invention;

FIGS. 11 to 13 schematically illustrate sections of printing presses that may be used to form light control layers that may be inspected according to the method and apparatus of the invention;

FIGS. 14(a) schematically shows a portion of a web and illustrates various positions where a light control layer may be applied for inspection;

FIG. 14(b) schematically shows a portion of a sheet and illustrates various positions where a light control layer may be applied for inspection;

FIGS. 15(a) to 15(f) illustrates examples of light control layers that may be inspected using the present invention;

FIG. 16 schematically illustrates a printing press incorporating an inspection module according to embodiments of the invention; and

FIGS. 17 to 19 schematically illustrate cross-sectional views of various banknote constructions comprising a test light control layer.

### DETAILED DESCRIPTION OF THE DRAWINGS

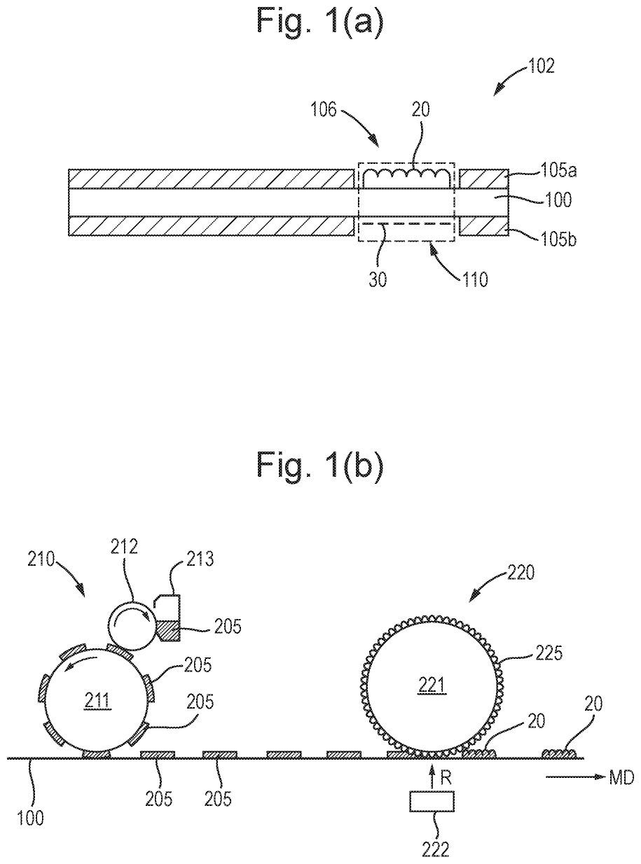

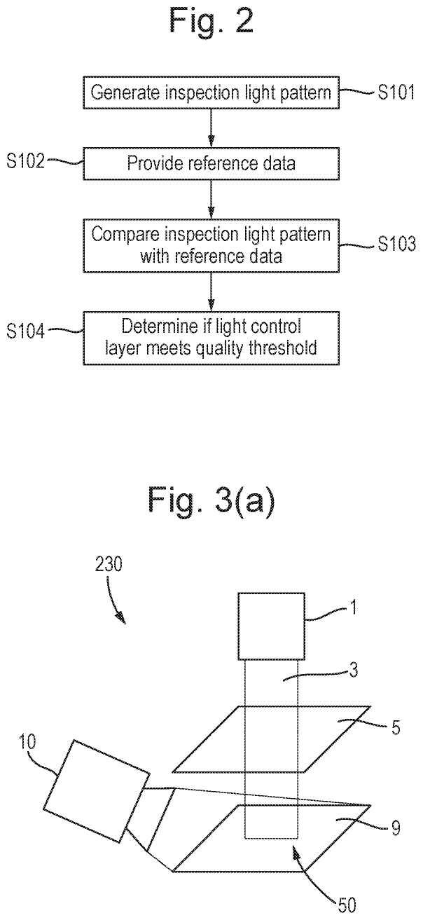

An example of a light control layer that may be inspected is shown in FIG. 1(a), which is a cross-sectional view of a security document (here a banknote) 102 having a security device 110 integrated therein. The banknote 102 comprises a transparent polymer substrate 100. On at least one of the surfaces of the polymer substrate 100, preferably both, one or more opacifying layers 105a, 105b are provided. Here, the opacifying areas are omitted in localised areas on both sides of the substrate to define a window region 106 in which the security device 110 is located. The security device comprises an effect-generating layer 30 on one side of the polymer substrate and light control layer 20 on the opposing side (although in alternative arrangements the effect-generating layer and light control layer can be provided on the same side of the substrate). The effect-generating layer and the light control layer cooperate with each other to provide a secure optically variable effect. In this example, the effect-generating layer is an image layer comprising a plurality of interlaced image segments, and the light control layer comprises an array of microlenses such that the security device 110 exhibits a lenticular optically variable effect as known in the art.

FIG. 1(b) schematically depicts a method of cast-curing a light control layer 20 (such as the one shown in FIG. 1(a)) that may subsequently be inspected using the present invention. This may be part of a process for manufacturing a banknote as seen in FIG. 1(a) for example. FIG. 1(b) shows the process as applied to a transparent support layer 100 (such as a polymer substrate for a banknote) which in preferred embodiments is a web or sheet as part of a web- or sheet-based process for forming security devices or security documents. However, in other embodiments the support layer 100 could be a separate support layer which is later applied to a security device or security document (e.g. the support layer 100 could be a transfer foil that may subsequently be applied to a security device by a foiling machine).

As shown in FIG. 1(b), a transparent curable material 205 is first applied to the support layer 100 using an application module 210 which here comprises a patterned print cylinder 211 which is supplied with curable material from a doctor chamber 213 via an intermediate roller 212. Thus, in the example of FIG. 1(b) the curable material is applied by flexographic printing. Other printing techniques such as lithographic, screen, gravure printing or offset printing could also be used for application of the curable material. Print processes such as these are preferred since the curable material 205 can then be laid down on the support 100 in specific regions, the size, shape and location of which can be controlled by the print process, e.g. through appropriate configuration of the pattern on the cylinder 211. However, in other cases, an all over coating method could be used, e.g. if the light control layer is to be formed all over the support 100. The curable material 205 is applied to the support 100 in an uncured (or at least not fully cured) state and therefore may be fluid or a formable solid.

The support 100 is then conveyed along a machine direction (MD) to a casting module 220 which here comprises a casting tool 221 in the form of a cylinder carrying a surface relief 225 defining the shape of the light control layer (e.g.

focussing elements) which are to be cast into the curable material 205. The surface relief 225 may be formed in the cylinder surface itself, or on a plate mounted to the cylinder. As each instance of curable material 205 comes into contact with the cylinder 221, the curable material 205 fills a corresponding region of the relief structure, forming the surface of the curable material into the shape defined by the relief.

Once the desired microstructures have been formed in the curable material so as to form the surface relief thereof, the curable material 205 is cured by exposing it to appropriate curing energies such as radiation R (typically UV radiation) from a source 222. This preferably takes place while the curable material is in contact with the surface relief 225 of cylinder 221 although if the material is already sufficiently viscous this could be performed after separation of the curable material from the casting cylinder 221. In the example shown in FIG. 1(b), the material is irradiated through the support layer 100 as the support layer is a substantially transparent substrate (that could be used, for example, as a security thread or foil, banknote substrate, security label, polycarbonate datapage or transfer foil), although the source 222 could alternatively be positioned above the support layer 100, e.g. inside the cylinder 221 if the cylinder is formed from a suitable transparent material such as quartz. Alternatively, the curable material 205 may be partially cured while in contact with the surface relief 225, with a subsequent cure performed after the curable material is released from the surface relief in order to fully cure the curable material. The radiation applied to cure the material after it is released from the surface relief may be directed through the support layer 100, or from above the support layer 100.

There are possible problems that may arise with such a casting process, however. One possible problem is that air bubbles may be introduced into the curable material during the casting, thus forming voids in the finished light control layer that may interact with light in an undesirable manner. Another possible issue is the accumulation of dirt or foreign matter on the surface relief of the casting cylinder, which adversely affects the casting process. The surface relief of the casting cylinder also wears over time, altering the geometry and/or dimensions of the surface relief. In some instances, the curable material may not peel off of the casting cylinder correctly as it is conveyed along the machine direction (e.g. due to under-curing), therefore generating an incorrectly formed light control layer. It is also possible that there may be a misregistration problem, in which the surface relief of the casting cylinder does not correctly align with the instances of curable material on the support layer. For example, this may happen if the surface relief 225 is in the form of a separate plate that is attached to the casting cylinder.

It will be appreciated by the person skilled in the art that the example light control layer and method of FIGS. 1(a) and 1(b) are exemplary only and provided for context, and that the present invention may be applied to inspection of transparent refractive light control layers formed by other methods such as a hot emboss process typically used for security threads and polycarbonate passport data pages (as described in WO2018/142129 for example), or suitable for different security devices. WO2017/009616 provides a number of examples of security devices and methods of manufacture, with light control layers that may be inspected using the present invention. WO2009/066048 provides examples of security devices having light control layers comprising prismatic microstructures, where the effect-generating layer comprises a colour shifting layer.

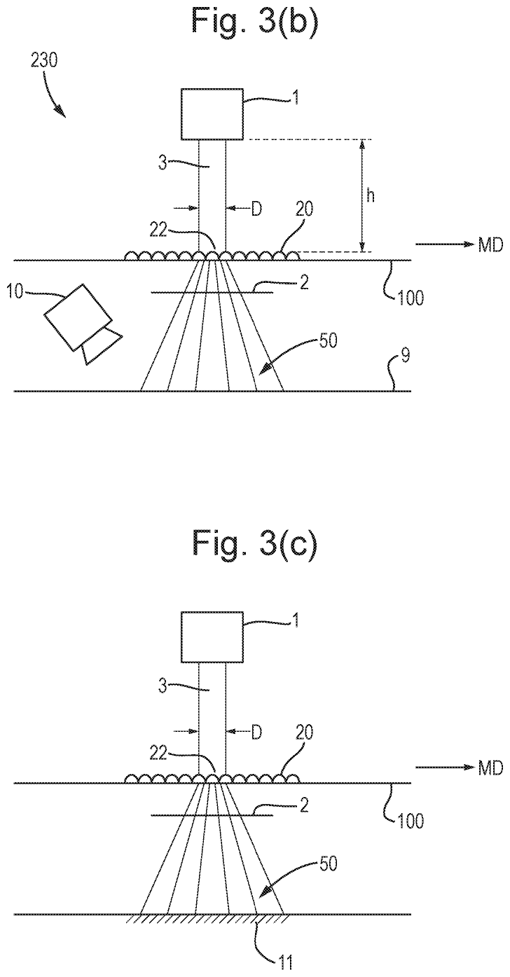

FIG. 2 is a flow diagram outlining the main steps of a preferred embodiment of inspecting a light control layer 20 comprising a plurality of refractive microstructures, for example as manufactured using the process outlined in

FIG. 1(b). It will be appreciated that the present invention may be used for inspection of light control layers having been formed by any suitable process.

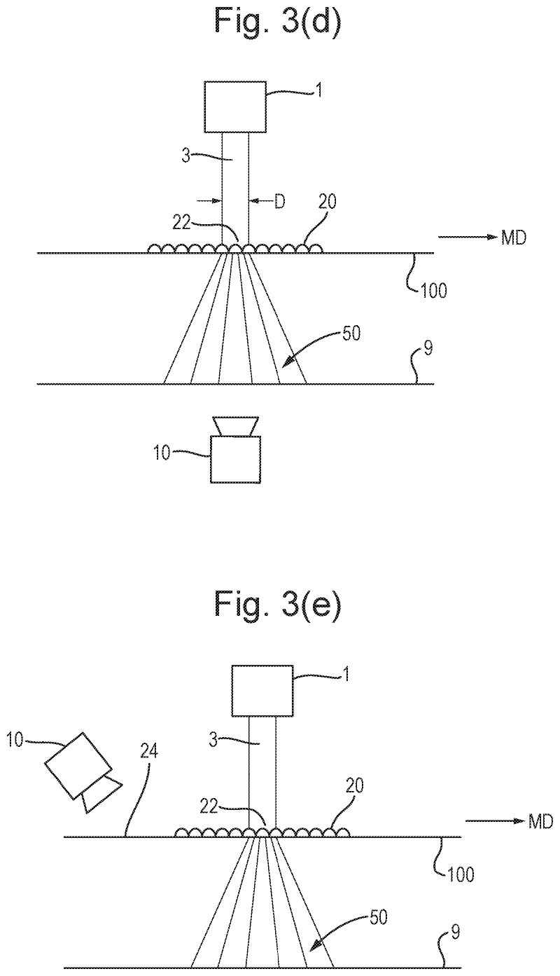

The flow diagram of FIG. 2 will be described with reference to FIGS. 3 to 7. At step S101, an inspection light pattern is generated. This is done using an inspection module 230, an example of which is shown in FIGS. 3(a) to 3(e). The inspection module 230 comprises a laser source 1. The laser source 1 generates a beam 3 of collimated, coherent and monochromatic light (as provided by the laser) that is directed (typically substantially perpendicularly) towards the light control layer. Due to the transparent nature of the curable material forming the light control layer, the laser light 3 passes through the light control layer and the resulting inspection light pattern 50 may be observed on a viewing screen 9 that is positioned on a distal side of the light control layer to the laser source 1. A camera 10 records the resulting inspection light pattern 50 as an image, with the image being used for further analysis.

In alternative embodiments, the viewing screen may be positioned on the same side of the light control layer as the laser source 1, and the inspection light pattern generated in reflection may be recorded by the camera 10 for inspection.

FIG. 3(a) schematically illustrates a beam of laser light 3 being directed towards a transparent polymer window which does not comprise a surface relief. The resulting inspection light pattern 50 is thus in the form of a single spot visible on the viewing screen 9.

However, when the laser light 3 is directed towards a light control layer 20 comprising a surface relief (e.g. as defined by an array of cylindrical micro lenses as illustrated in FIG. 3(b)), the resulting inspection light pattern 50 is in the form of a plurality of spots. In FIG. 3(b) each cylindrical micro lens is elongate along a first direction (into the plane of the page in the orientation of FIG. 3(b)), and the plurality of spots in the inspection light pattern are linearly orientated transverse to the direction of elongation of the micro lenses. In this way, the presence of a surface relief of the light control layer is readily detectable by the presence of multiple spots in the inspection light pattern.

The elongate microlenses of the light control layer 20 illustrated in FIG. 3(b) are an example of “one dimensional” refractive microstructures, where the optical effect exhibited by said structures is more strongly observed in substantially one viewing direction. One dimensional microstructures are typically elongate along a particular direction, and the resulting spot pattern in the inspection light pattern is typically linearly orientated substantially perpendicular to the elongate direction.

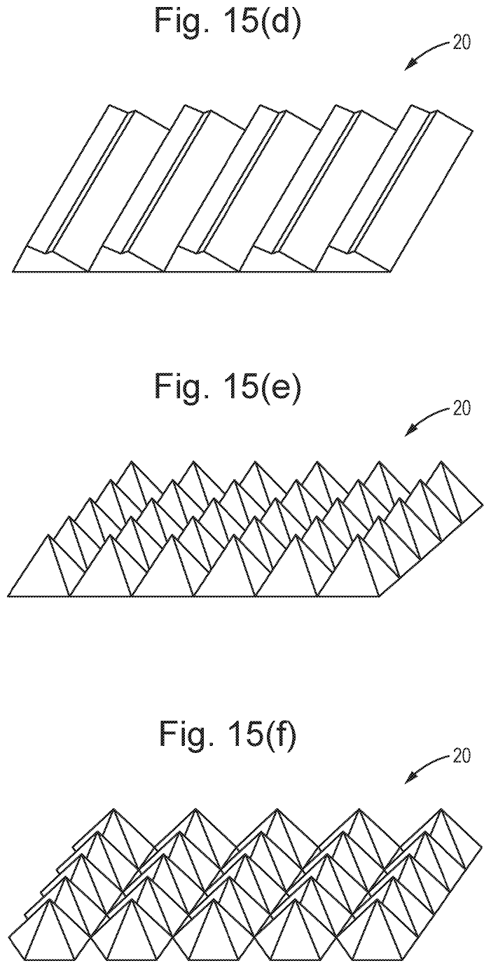

FIG. 15(a) is a perspective view of an array of one-dimensional elongate microlenses such as those of FIG. 3(b). Opposing end faces of an individual microlens 20a are substantially parallel, and such a microlens is known as a “one-dimensional” microlens. The light control layer 20 shown in FIG. 15(a) is therefore a one-dimensional structure as it comprises a plurality of one-dimensional microlenses. The term “one-dimensional” is used because the optical effect produced by the array of microlenses is significantly stronger (i.e. more noticeable to a user) in one direction of viewing. The optical effect exhibited by the light control layer is therefore anisotropic. If a security device comprising such a light control layer is rotated within its plane, the exhibited optical effect is seen most readily when the device is tilted with the viewing direction perpendicular to the long axes of the microlenses (i.e. along Y-Y′). If the device is rotated such that the viewing direction is parallel with the long axes of the microlenses (i.e. along X-X′), the effect is seen to a lesser extent.

FIGS. 15(b) to 15(f) are perspective views of further light control layers comprising refractive microstructures that may be inspected in the present invention. FIG. 15(b) illustrates a light control layer 20 comprising an array of elongate linear microprisms 2100 having a triangular cross section. FIG. 15(c) illustrates a light control layer 20 comprising a plurality of microprisms 2200 each having a “saw-tooth” structure, in that one facet (shown here at 1100) defines a more acute angle with its supporting substrate than the other facet of the microprism (shown at 1200). Such a saw-tooth structure, when viewed from direction A, will provide an optical effect that occurs over a narrow angle of tilt. Conversely, when viewed from direction B, the optical effect occurs over a relatively large angle of tilt.

The light control layer may comprises a series of multi-faceted microprisms (i.e. having more than two facets), as shown in the example light control layer 20 of FIG. 15(d).

The invention may also be used for inspection of “two dimensional” light control layers comprising “two dimensional” refractive microstructures, where the optical effect is strongly observed in two (or more) viewing directions. Such “two dimensional” light control layers are therefore not as rotationally dependent as one-dimensional light control layers. In the case of two dimensional microstructures, the inspection light pattern typically comprises two (or more) linear arrays of spots. Such examples include spherical lenses, corner cubes, square based pyramid microprisms as depicted in the light control layer 20 of FIG. 15(e), or more generally polygon-based pyramidal microprisms such as the hexagonal based pyramidal microprisms seen in the light control layer 20 of FIG. 15(f). The invention is not limited to the example light control layers depicted in FIGS. 15(a) to 15(f).

Referring back to FIG. 3(b), the laser source 1, camera 10 and viewing screen 9 together form inspection module 230. The transparent web or sheet 100 carrying the light control layer is conveyed through the inspection module 230 along a machine direction MD as illustrated in FIG. 3(b). The inspection module 230 may optionally comprise an optical filter 2 positioned between the light control layer 20 and the viewing screen 9 to filter out unwanted spectral components. In the arrangement illustrated in FIGS. 3(a) and 3(b), the laser source 1 and camera 10 are positioned on opposing sides of the web or sheet substrate 100. However, other configurations of the inspection module 230 are envisaged, as described below with reference to FIGS. 3(c) to 3(e).

FIG. 3(c) illustrates an example inspection module 230 comprising a photosensitive sensor 11 instead of a camera 10. Here, the beam of laser light 3 is directed through the substantially transparent light control layer 20 and substrate 100 as before, and the inspection light pattern 50 is projected directly onto photosensitive sensor 11 such as a CCD or CMOS sensor. An optical filter 2 may optionally be positioned between the light control layer and the sensor 11 in order to remove unwanted spectral components being exhibited in the inspection light pattern.

FIG. 3(d) schematically illustrates a further example of an inspection module 230 where the inspection light pattern 50 is projected onto a viewing screen 9 that is transparent or partially transparent. In this example, the camera 10 (or photosensitive detector 11) is positioned on a side of the viewing screen 9 opposite to the light control layer 20.

FIG. 3(e) schematically illustrates a further example of an inspection module 230 that may be used in the present invention. In this example the laser source 1 and camera 10 are positioned on the same side of the substrate 100. The inspection light pattern 50 is projected onto viewing screen 9 and the camera 10 records an image of the inspection light pattern through a region 24 of the transparent substrate 100 that does not contain a light control layer. An inspection module 230 with this configuration may find particular utility on the production of security threads and foils.

In a yet further arrangement of inspection module 230, the laser source 1 and camera 10 may be positioned on the same side of the substrate 100 in the same manner as in FIG. 3(e), but the camera is positioned so as to record the inspection light pattern through the light control layer.

As shown in FIGS. 3(b) to 3(e), the laser beam 3 has a diameter (or “spot size”) D that is larger than a pitch of the cylindrical micro lenses, which pitch is typically in the range of 5 to 100 microns, preferably 20 to 60 microns. The beam diameter D is typically in the range of 50 microns to 10 millimetres, preferably 500 microns to 5 millimetres, and therefore the region 22 towards which the laser light 3 is directed typically covers (overlaps with) a plurality of individual microstructures. Therefore, the beam 3 passes through multiple structures in order to form the light pattern 50.

In these examples the laser source has a power of 1 mW, but may have a power in the range of 1 mW to 20 mW, preferably 1 mW to 5 mW and is positioned a distance from the light control layer, h, of 5 mm to 1000 mm, preferably 10 mm to 100 mm .

In the examples of FIGS. 3(b) to 3(e), the light control layer is moving along the machine direction MD and so the inspection light pattern will be continuously updated as the beam 3 falls incident on different parts of the web or sheet. The camera 10 may be configured to capture a series of images as a substantially continuous video, or a set of discrete single images at predetermined time intervals. For example, in a process for manufacturing banknotes, the light control layers will be cast in register with laterally spaced window regions of the banknotes on the web or sheet, and the camera 10 may be configured to record an image at each time instance a light control layer passes through region 22 upon which the laser beam 3 is incident.

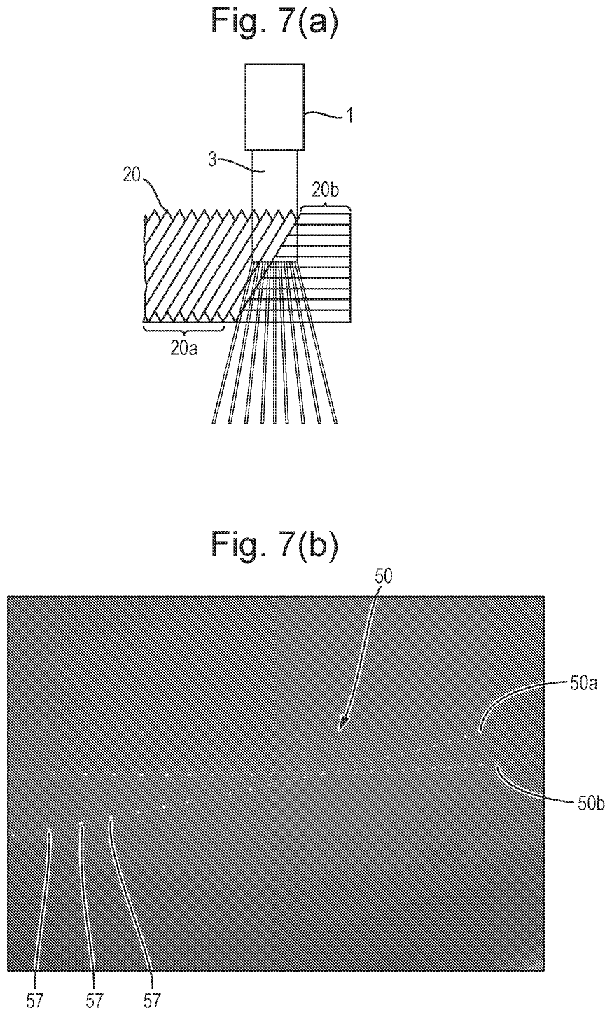

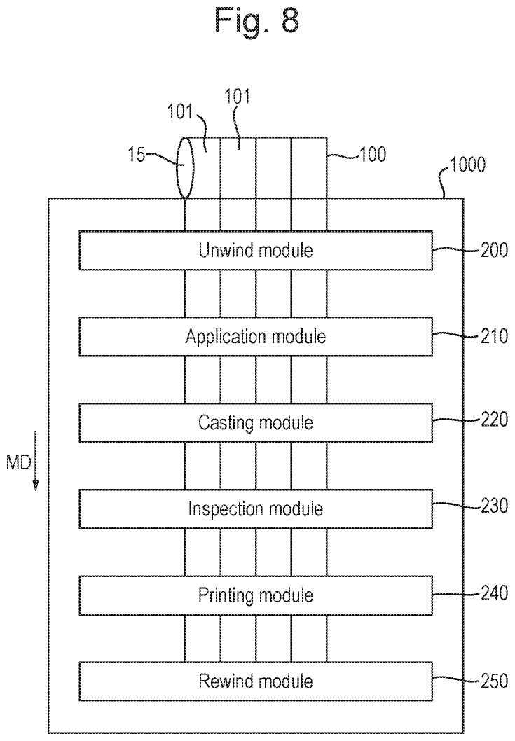

Referring back to FIG. 2, at step S102, reference data is provided that is indicative of a light control layer that meets a predetermined quality threshold. This may be in the form of a reference light pattern 55 (see FIG. 5(a)) that has been obtained by directing a beam of laser light through a light control layer that is known to meet the predetermined quality threshold. For example, such a reference light control layer may have been inspected under a microscope to determine that it meets (i.e. exceeds) the predetermined quality threshold, for example pitch, skew, regularity and integrity of the microstructures. Alternatively the reference light pattern could be generated using data calculated based on the known light source (e.g. laser) parameters and the surface relief of the light control layer being inspected.

At step S103, the inspection light pattern is compared to the reference data. In the case above where the reference data is in the form of a reference pattern, the reference pattern may simply be compared to the inspection light pattern generated at step S101 to efficiently determine whether newly-cast light control layers meet a predetermined quality threshold.

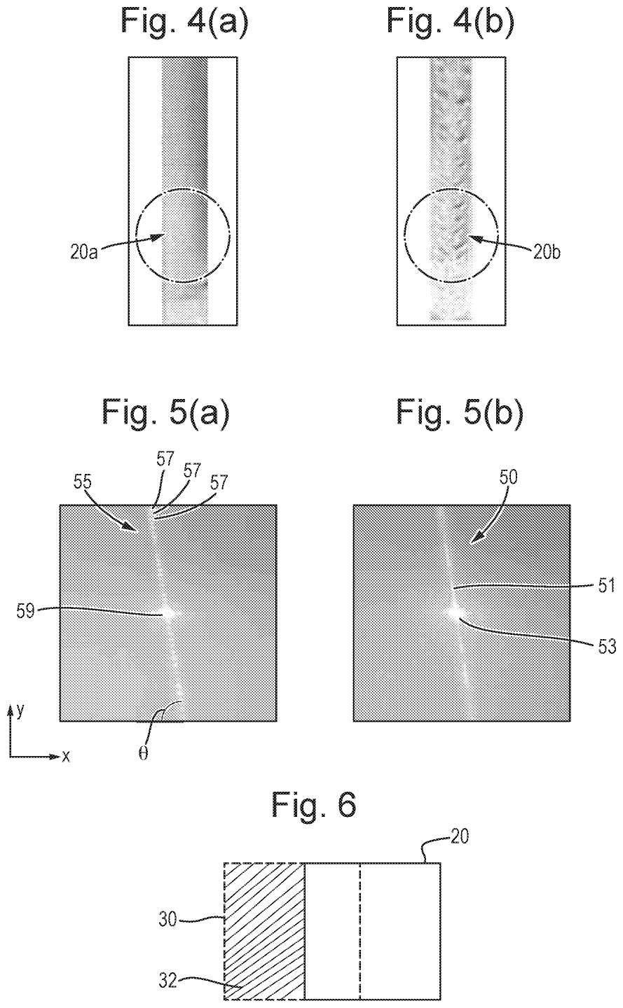

This concept is illustrated with reference to FIGS. 4(a) and 4(b), and FIGS. 5(a) and 5(b). FIG. 4(a) is a top-down “macro” image (obtained using a standard camera) of a microlens array 20a that meets the predetermined quality threshold, and FIG. 4(b) is a top-down “macro” image of a microlens array 20b that does not meet the predetermined quality threshold. Each image in FIGS. 4(a) and 4(b) is of approximately 50 cylindrical lenses of 60 micron pitch. The lens array 20a may have been used to generate the reference light pattern 55 (shown at FIG. 5(a)), which exhibits a highly ordered and discrete spot pattern, with the individual spots shown at 57. The reference light pattern 55 also exhibits a high resolution (i.e. not “blurred”) central spot 59 originating from the laser beam 3.

Now suppose that the light control layer 20b is to be inspected by the inspection module 230. An image of the obtained inspection light pattern 50 is illustrated at

FIG. 5(b). As can be seen from this image, the light pattern 50 does not display the same highly ordered and discrete pattern of spots 57 as seen in the reference pattern 55. Instead, inspection light pattern 50 exhibits a substantially solid line (shown at 51) where the individual spots have merged into a single feature. The central spot 53 is also blurred in comparison to the reference pattern 55.

At step S104, it can therefore be determined simply by a visual comparison between the inspection light pattern 50 and the reference light pattern 55 that the light control layer 20b does not meet the predetermined quality threshold.

If a light control layer does not meet the predetermined quality threshold, it may be referred to as having a “defect” (for example, the inspection light pattern obtained from the inspected light control layer may be indicative of defective pitch or skew). Such a defect may be continuous (it is present in substantially each light control layer that is formed by the web or sheet process); or it may be discrete (the defect is present in only some of the cast light control layers). In a web-based process, if the defect is discrete the web material may be marked at the position of the defect (and/or the location of the defect noted) for subsequent removal. If the defect is continuous in a web-based process, corrective action may be performed to correct the error, for example either while the web process is in progress or by stopping the web-based process to perform the correction.

In a sheet-based process, if the defect is discrete, the sheet material may be marked (or the position of the defect noted) for subsequent removal of that sheet. Alternatively, the defective sheet may be directed to a reject pile that is separate to sheets that passed the inspection process. If the defect is continuous, corrective action may be performed in a similar manner to a web process, e.g. during the process itself or by stopping the process in order to perform the correction.

If the inspection module 230 is being used for authentication of a security document having a security device comprising the light control layer, the document may be determined as a counterfeit as the microstructures of the light control layer do not meet the quality threshold.

Such a visual comparison between the inspection light pattern and the reference pattern may be performed by an operator (i.e. “on the fly”). In such cases it is not essential to record the inspection light pattern as an image, and the comparison may be made by viewing the viewing screen 9 and comparing this to the reference light pattern.

In the above examples, the reference data is in the form of a reference pattern. In embodiments, the reference data may be in the form of a reference value for one or more predetermined metrics. In such embodiments, step S103 comprises detecting an inspection value of the predetermined metric(s) from the inspection light pattern, and comparing the detected inspection value or values with the corresponding reference value(s). This may be performed alternatively or in addition to visual inspection.

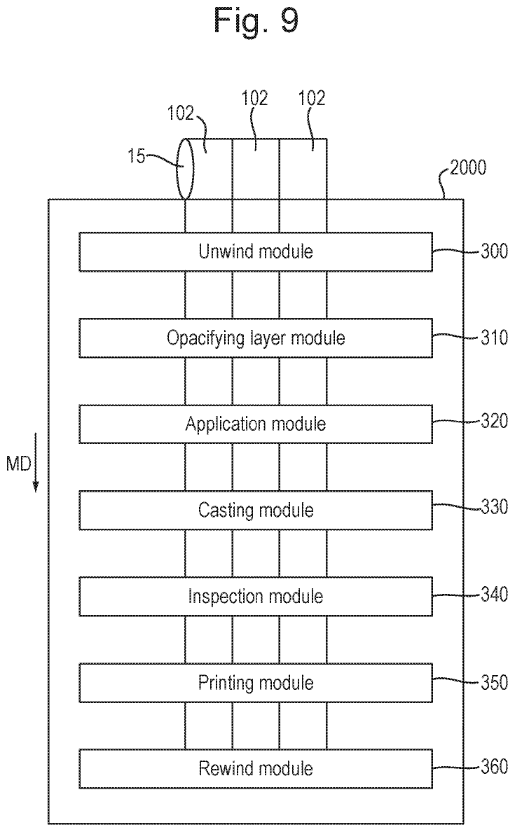

The predetermined metric may be a number of elements (e.g. spots) in the light pattern when the beam of laser light is directed towards the region where the light control layer is expected to be. For example, if there is only a single spot recorded by camera 10, then this is indicative that no surface relief (i.e. no light control layer) is present. This metric may be useful to determine misregistration defects during manufacture, as schematically illustrated at FIG. 6. FIG. 6 illustrates a region (delimited by dashed line) 30 where the light control layer was intended to have been cast on the web or sheet. The actual footprint of the cast light control layer is indicated by the solid line at 20. Therefore, if the laser light 3 of inspection module 230 is directed towards shaded region 32 where it is expected that the surface relief of the light control layer is present, then only a single spot will be present in the inspection light pattern. The detection of such a single spot is indicative of the light control layer falling below the predetermined quality threshold (here laterally misregistered with respect to the substrate).

Another metric which may be used is a resolution (e.g. a size of discrete spots or a number of discrete spots per unit length) of the inspection light pattern 50. For example, the reference data may comprise a reference value for a resolution of the inspection light pattern below which the light control layer would fail the quality inspection. Therefore, a resolution of the inspection light pattern 50 may be detected and compared to the reference resolution value in order to determine whether the light control layer meets the quality threshold. In the example inspection light pattern 50 shown in FIG. 5(b), the detected resolution of inspection light pattern 50 is lower (e.g. fewer sport per inch) than that of the reference pattern 55.

The predetermined metric may be an intensity and/or brightness of the light pattern, with the reference data comprising a value of the intensity and/or brightness of the light pattern. If the detected intensity of the inspection light pattern is below the reference value for the intensity of the inspection light pattern, then it can be inferred that the light control layer does not meet the predetermined quality threshold.

The orientation of the spots of the inspection light pattern is dependent on the orientation (“skew”) of the cast microstructures of the light control layer. For example, we saw in FIG. 3(b) that the individual spots of the inspection light pattern 50 are aligned substantially perpendicular to the direction of elongation of the micro lenses. Therefore, an orientation of the inspection light pattern can be used as a predetermined metric in order to determine whether the cast light control layer meets the predetermined quality threshold for skew of the microstructures of the light control layer relative to the substrate. For example, referring back to FIG. 5(a), we can see that the reference light pattern 55 is in the form of a line of discrete dots that make an angle of 0 to the horizontal (x-axis). Thus, the angle of orientation of the inspection light pattern 50 can be compared to this reference value of the orientation. In such cases, it will be appreciated that the orientation of the camera must be the same for both of the capture of the reference light pattern and the inspection light pattern, or the difference in camera orientation between the capture of the reference light pattern and inspection light pattern is known.

The pitch of the spots (e.g. a separation distance of the spots) of the inspection light pattern is dependent on (and therefore indicative of) the pitch of the microstructures of the cast light control layer. Therefore, the predetermined metric may be a pitch of the inspection light pattern, from which the pitch of the light control layer microstructures may be inferred. Thus, it may be determined whether the light control layer meets the predetermined quality threshold based on pitch.

In cases where the reference data comprises reference values for one or more predetermined metrics, the reference values may be obtained from a reference light pattern, or obtained from computer simulation methods (e.g. when the properties of the laser and the light control layer to be inspected are known).

Values for more than one predetermined metric may be obtained from the inspection light pattern (e.g. values for the intensity, resolution and pitch of the pattern) and compared to the reference values. In such a case, typically the light control layer will be deemed to have met the quality threshold only if the detected values meet the reference values for each metric.

The reference value of a predetermined metric in the reference data may take into account an acceptable level of tolerance for the inspected light control layer. In other words, the reference value of a predetermined metric may be set at a predetermined percentage of reference value for a “perfect” light control layer. For example, if the orientation of the reference light pattern obtained from a perfectly cast light control layer is at an angle of 90 degrees, the predetermined value for that metric may be the range of 88-92 degrees inclusive. An inspection light pattern having an orientation falling within the predetermined range will then be determined to have met the predetermined quality threshold within the accepted tolerance. As another example, the brightness of the light pattern obtained with a “perfect” light control layer may be 50 lumens. If the reference value for that metric is then set at 48 lumens, then any light control layer producing an inspection light pattern having a brightness of 48 lumens or greater will be determined to meet the predetermined quality threshold within accepted tolerance.

Referring back to FIG. 2, at step S104, it is determined if the light control layer meets the predetermined quality threshold based on the results of the comparison, for example whether or not the detected value for a particular metric is equal to or exceeds the reference value for that metric.

Steps S103 and S104 are typically performed by an appropriately programmed processor at the inspection module 230. The reference data may be stored in local storage at the inspection module 230, or stored remotely and accessed over a network such as a local area network (LAN) or the internet.

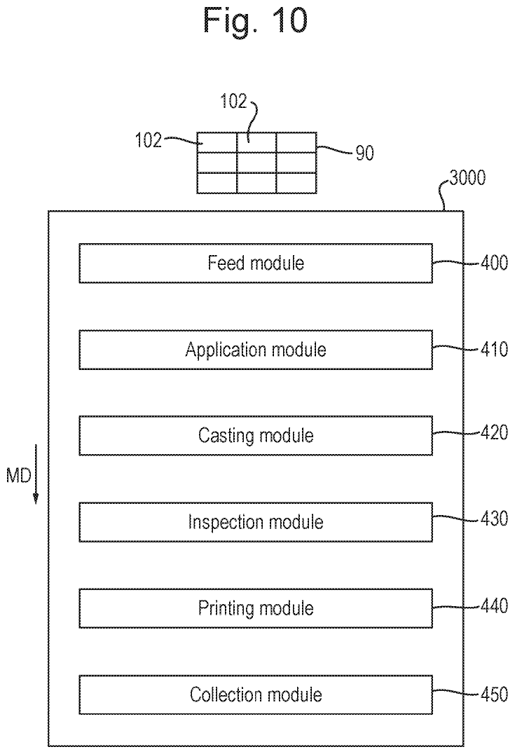

FIGS. 7(a) and 7(b) further illustrate how an orientation of the inspection light pattern may be used to determine whether the light control layer meets a predetermined quality threshold (e.g. skew). In FIG. 7(a), the light control layer 20 comprises two arrays of linear elongate triangular microprisms, with the array indicated at 20a angularly offset from the array indicated at 20b. Thus, the inspection light pattern 50 will have differing orientations for these two arrays. Therefore, as shown in FIG. 7(a), when the laser beam 3 of inspection module 230 is simultaneously incident on microstructures from both arrays 20a and 20b (in other words is simultaneously incident on microstructures having different orientations), the resultant inspection light pattern produces two (or more, depending on the number of angularly offset arrays in the light control layer) angularly offset linear arrays of spots 57, as shown in FIG. 7(b). FIG. 7(b) is an image of the inspection light pattern captured by a camera 10, with the array of spots 50a corresponding to a first array of microprisms, and the line of spots 50b corresponding to the other array.

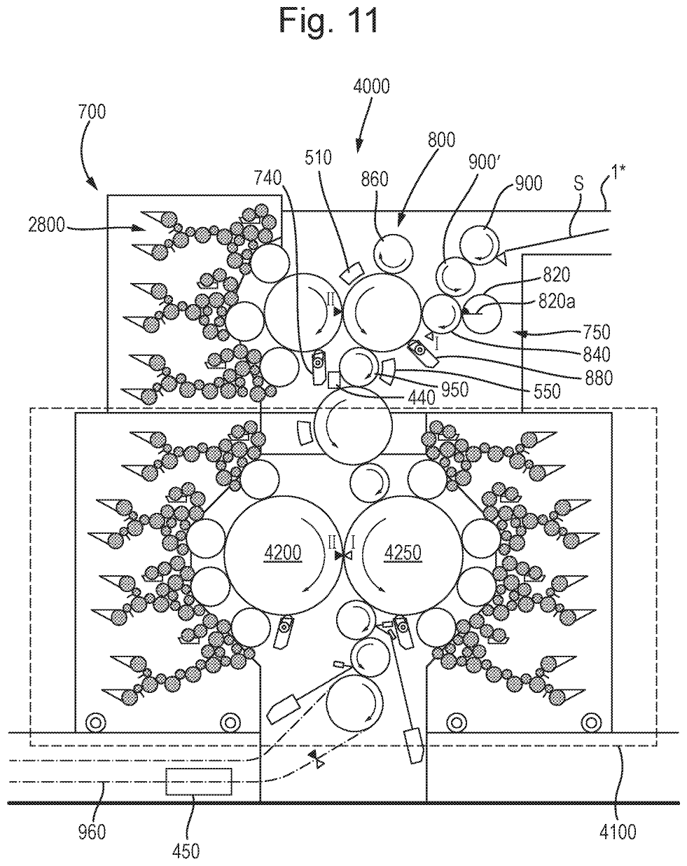

FIG. 8 schematically illustrates an in-line web-based printing press 1000 incorporating an inspection module 230 according to an embodiment of the invention. In this example the printing press is configured for manufacturing security threads or foils, illustrated at 101. A web of transparent polymer substrate 100 (e.g. PET) is supported on a cassette 15 and introduced to unwind module 200, which conveys the web along the machine direction MD. Although the web in this example is a polymer web, it will be appreciated that the present invention is also applicable to paper-based security documents (e.g. which incorporate transparent windows).

The printing press 1000 comprises an application module 210 and a casting module 220 (for example as described with reference to FIG. 1(b)), where the desired light control layer is cast on to the transparent web substrate in the manner as has been discussed above.

Once the light control layers have been cast on the web 100, the web is conveyed along the machine direction to inspection module 230, for example an inspection module as described in FIGS. 3(a) to 3(e). At the inspection module 230, it is determined whether the light control layer that has been applied and cast upstream by application module 210 and casting module 220 meets a predetermined quality threshold, using any of the techniques described hereinabove.

If it is determined that the light control layer under inspection does not meet the predetermined quality threshold, then that area of the web may be marked (or the position thereof noted) for subsequent removal of that thread/foil; or the printing process may be stopped and action taken to correct the defect.

In this example, the light control layer that is formed by application module 210 and casting module 220 forms part of a security device formed on or integrated within the security thread or foil. The final security device may typically include a further effect-generating layer that is designed to optically cooperate with the light control layer in order to form the final security device. For example, in the case where the light control layer comprises an array of microlenses the effect-generating layer may be an image layer that cooperates with the array of microlenses in order to generate a lenticular optically variable effect. In another example where the light control layer comprises an array of microprisms, the effect-generating layer may be a colour-shifting layer (e.g. thin-film interference stack, liquid crystal layer or optically variable pigment). The effect generating layer is applied by printing module 240 in register with the light control layer.

The web 100 is then re-wound at rewind module 250. The web produced by printing press 1000 may then be subjected to further processing steps, for example application of further functional layers or features to the security threads, e.g. metallisation, magnetic and/or adhesive layers. A cutting machine may then slit the web 100 into elongate security threads. Any region(s) of the web that was marked or noted as having a light control layer that did not meet the predetermined quality threshold may then be discarded.

FIG. 9 schematically illustrates an example of an in-line web-based printing press 2000 configured to manufacture polymer banknotes, for example as shown in FIG. 1(a). The web-based printing press 2000 comprises an inspection module 340 according to an aspect of the invention and may be, for example, any inspection module as schematically illustrated above in FIGS. 3(a) to 3(e).

A reel 15 of transparent polymer substrate 100 is introduced to unwind module 300. The web of substrate comprises an mxn matrix of banknotes 102 (here, “banknote” is used to refer to banknotes at all stages of their production). The unwind module 300 conveys the web 100 through the press 2000 along the machine direction MD.

An opacifying layer module 310 applies opacifying layers to the recto and verso sides of the substrate web. The opacifying layers are omitted in localised areas so as to define window region(s) of the banknotes as is known in the art. The opacifying layer module 310 may also be used to apply an electrically conductive layer to the banknotes.

Subsequently to the opacifying layers being applied, application module 320 applies transparent curable resin to the window regions of the banknotes, which is embossed and cured at casting module 330 in order to form light control layers on the banknotes.

It will be appreciated that in alternative embodiments the opacifying layers may be applied at different points in the process. In one alternative embodiment the infeed material on reel 15 already comprises opacifying layers defining window region(s) of the banknotes with the light control layers registered to the window regions. In another alternative embodiment the opacifying layers are formed after the light control layers are formed.

The substrate web is conveyed to inspection module 340 where the formed light control layers are inspected as described above, and a determination is made as to whether or not they meet the predetermined quality threshold. For example, lateral registration of the cast light control layer is particularly important when forming the light control layers within predetermined window regions of the banknotes. If it is determined that the light control layer under inspection does not meet the predetermined quality threshold, then that area of the web may be marked (or the position thereof noted) for subsequent removal of that banknote;

or the printing process may be stopped and action taken to correct the defect.

At printing module 350, an effect-generating layer is printed within the window region(s) of the respective banknotes for optical cooperation with the applied light control layer. As discussed above, this effect-generating layer may typically be an image layer (e.g. for lenticular devices) or a colour shifting layer (e.g. for light control layers comprising prismatic microstructures). The effect-generating layer is typically applied to the opposing side of the substrate web to the side on which the light control layer was cast.

The substrate web is then re-wound at rewind module 360. The web may then be provided to a cutting machine for cutting into sheets. At this point, banknotes having light control layers that did not meet the predetermined quality threshold at inspection module 340 may be discarded. The sheets of “good” banknotes may then pass through further finishing machine(s) for application of print works (e.g. lithographic, intaglio and screen workings), numbering, varnishing and finally cutting into individual bank notes.

FIG. 10 schematically illustrates a printing press 3000 configured to manufacture polymer banknotes (such as shown in FIG. 1(a)) in a sheet-based process. The sheet-based printing press 3000 comprises an inspection module 430 according to an aspect of the present invention. Here, sheets of transparent polymer substrate 90 comprising a matrix of mxn banknotes 102 are introduced to the printing press 3000 at feed module 400. The sheets are conveyed through the press along the machine direction MD. Unlike in the web-based process for manufacturing polymer banknotes described above with reference to FIG. 9, in this sheet-based example the banknotes 102 on the sheet already have opacifying layer(s) applied to them in order to define windowed and non-windowed regions of the banknotes.

As the sheets are conveyed along the machine direction, light control layers are formed on the banknotes within the lateral confines of the window regions by application module 410 and casting module 420 in the manner described above.

The sheets of polymer substrate, now comprising light control layers, are then conveyed through inspection module 430 where it is determined whether or not the cast light control layers meet a predetermined quality threshold. In the case where a defect is detected, the respective sheet may be marked for subsequent removal.

Printing module 440 then applies an effect-generating layer (e.g. image layer or colour shifting layer) to the opposing side of the substrate sheet in order to form the security device incorporated into the banknote.

Once the effect-generating layer has been applied by printing module 440, the sheets are collected at collection module 450. Sheets containing defects as determined at inspection module 430 (and marked or noted as such) are directed to a reject pile. The remaining “good” sheets may then be provided to further finishing machines for application of print works (e.g. lithographic, intaglio and screen workings), numbering, varnishing and finally cutting into individual bank notes.

In the example printing presses described above with reference to FIGS. 8, 9 and 10, inspection takes place after the light control layers have been formed but before the effect-generating layer is printed. Thus, the beam of laser light is able to pass through the transparent light control layer and transparent substrate to form the inspection light pattern. It will be appreciated that the inspection may take place after the effect-generating layer has been applied, as long as the level of transparency is sufficient for the laser beam to form the inspection light pattern. For example, where the effect-generating layer is in the form of a fine line pattern (e.g. for lenticular devices), it has been observed that the interaction of the laser beam with the fine lines is negligible, such that the inspection light pattern is substantially as a result of the interaction between the laser beam and the microstructures of the light control layer. In examples where inspection occurs after the effect-generating layer has been applied, the inspection takes place before any further opaque layers that would prevent transmission of the laser beam (e.g. an opaque absorber layer used with substantially transparent liquid crystal effect-generating layers) are applied. Alternatively, the inspection light pattern may be analysed in reflection.

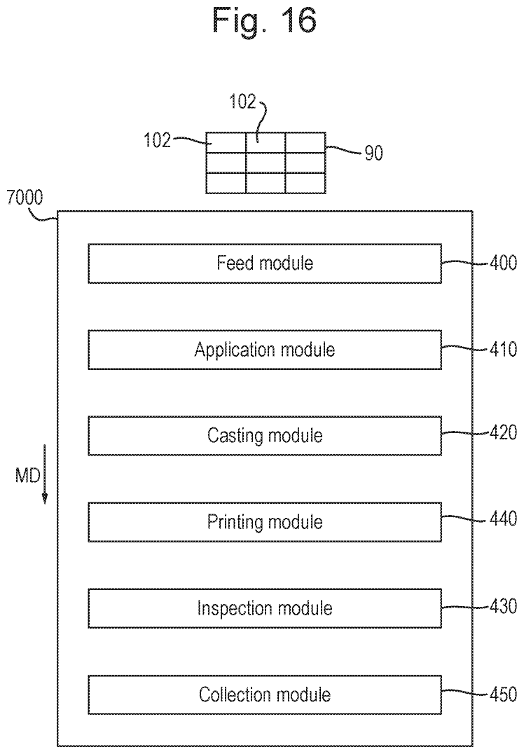

An example printing press 7000 where the inspection takes place after the effect-generating layer has been applied is schematically shown in FIG. 16.

The printing press 7000 is substantially identical to the press 3000 illustrated in FIG. 10, except that the inspection module 430 is downstream of the printing module 440.

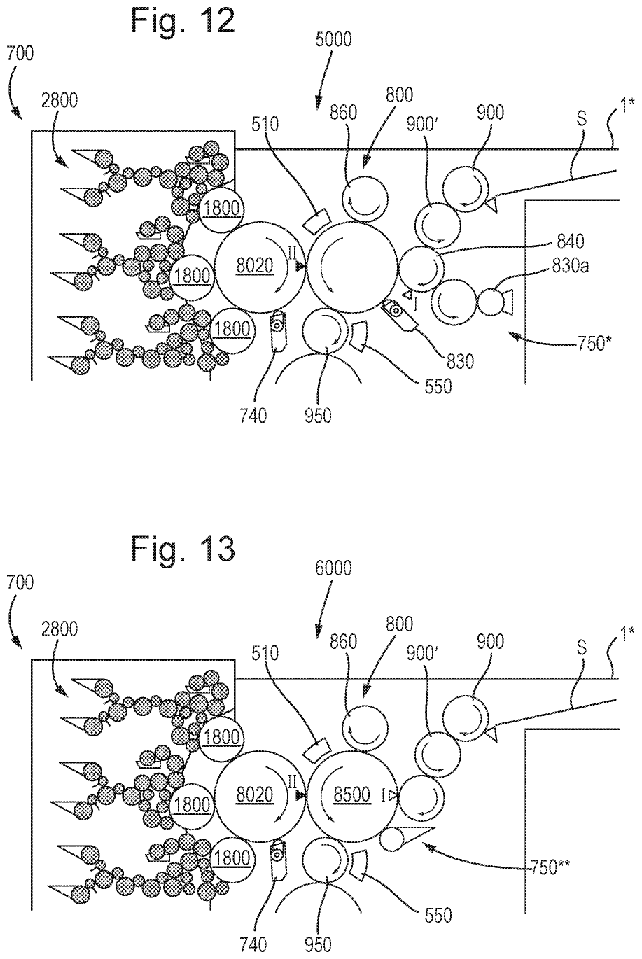

In FIGS. 8 to 10 and 16, the printing module for applying the effect-generating layer was positioned downstream of the application and casting modules for forming the surface relief of the light control layer. FIGS. 11 to 13 illustrate further preferred examples of sheet-based printing presses, where the light control layer is cast in substantially the same process step as the printing of the effect-generating layer. Inspection of the light control layer according to the invention may then occur after the substantially simultaneous formation of the effect-generating layer and the light control layer as long as the effect-generating layer is sufficiently transparent at the time of inspection, as explained above. FIG. 11 schematically shows a partial side view of a printing module 700, application module 750 and a casting module 800 of a printing press 4000.

Sheets S of transparent substrate having a first side I and a second opposing side II are fed onto feeder table 1* where they are conventionally aligned before being fed to sheet transfer cylinder 900. The sheets are then fed in succession by the sheet transfer cylinder 900 to additional sheet transfer cylinder 900′ to in-line application module 750. In the printing press 4000, the application module 750 is a screen printing module and comprises a rotatory screen cylinder 820 inside which is provided a squeegee device 820a, which rotary screen cylinder 820 cooperates with an impression cylinder 840, serving as a counter-pressure cylinder, onto which the sheets S are fed in succession from the transfer cylinder 900 at the infeed. More precisely, the sheets are transferred in succession to the impression cylinder 840 which supports the second side II of the sheets S and the rotary screen cylinder 820 is brought into contact with the first side I of the sheets. In this context, the application module 750 is adapted to apply of layer of transparent curable material on a portion of the first side of the sheets (for instance on a window region formed on the substrate by opacifying layers).

Downstream of the impression cylinder 840, there is provided casting module 800 comprising at least one casting cylinder 8500, serving as an embossing tool, which cooperates with the first side I of the sheets S, i.e. the side where the layer of transparent curable material was applied by application module 750. In this example, the embossing tool carries a surface relief configured to form an array of microlenses in the curable material. A pressure roller or cylinder 860 is furthermore advantageously provided about the circumference of the casting cylinder 8500 in order to cooperate with the second side II of the sheets and press them against the circumference of the casting cylinder 8500. The casting module 800 further comprises UV/drying units 510, 550 to cure the curable material. An automatic washing device 880 is provided for cleaning the surface of the casting cylinder during maintenance operations.

The printing press 4000 further comprises printing module 700, comprising print cylinder 8000, plate cylinders 1800 and inking apparatuses 2800. The printing module 700 is configured to apply an effect-generating layer, in this example a fine line ink pattern for a lenticular device. The printing cylinder 8000 collects inks from the set of plate cylinders 1800 that are inked by the inking apparatus 2800. The printing module further comprises an automatic blanket washing device 740 adapted to clean the surface of the print cylinder 8000 during maintenance operations.

The embossing cylinder 8500 is arranged so as to act as counter-pressure cylinder for the print cylinder 8000 of the printing module 700. In other words, in-line casting of the light control layer 20 is performed from and on the first side I of the sheets S and the effect-generating layer is printed on the second side II of the sheets S, which sheets S are still being supported on the embossing cylinder 8500, i.e. without involving any sheet transfer between the in-line casting of the light control layer and the printing of the effect-generating layer. This is particularly advantageous in terms of achieving a high register between the microstructures of the light control layer and the associated effect-generating layer as the light control layer and the effect-generating layer are applied in the same step without involving any sheet transfer operation, i.e. substantially simultaneously.

A transfer cylinder 950 transfers the sheets S away from the printing and casting modules towards a further printing section of the press 4000, said further printing section labelled 4100. Further print workings may be provided, substantially simultaneously, to both sides I and II of the sheets S by further printing section 4100 at the nip between print rollers 4200 and 4250. Subsequent to the further print workings applied to the sheets S by print section 4100, the sheets are conveyed by sheet conveying system 960 (such as a chain gripper system with spaced-apart gripper bars) for delivery, for example, at a sheet delivery unit (not shown). Sheets containing light control layers not meeting the predetermined quality threshold may be sorted into a separate pile at the sheet delivery unit, for example. FIG. 11 schematically shows two possible locations for an inspection module according to the invention with the printing press 4000. For clarity the inspection modules have been indicated by boxes in FIG. 11, but it will be appreciated that they may be of the form of any of the inspection modules as discussed herein, for example with reference to FIGS. 3(b) to 3(e). A first possible location for an inspection module (indicated at 440) is after the application of the effect-generating layer and the light control layer, but before transfer of the sheets to the further printing section 4100. A second possible location for an inspection module (indicated at 450) is at the sheet conveying system 960, i.e.

after the further print workings have been applied. In both cases, the transparency of the window region within which the light control layer has been applied is sufficient for the beam of collimated light of the inspection module to pass through the window region and form the inspection light pattern. Alternatively, the inspection light pattern may be generated in reflection. Other possible locations of the inspection module within the printing press are envisaged.

FIG. 12 schematically shows a partial side view of a printing module 700, casting module 800 and application module 750* of a printing press 5000. The only difference between the printing press 5000 of FIG. 12 and the printing press 4000 of FIG. 11 is that the application module 750* in FIG. 12 makes use of flexographic printing to apply the curable material, rather than the screen printing application module of FIG. 11. The further printing section has been omitted from FIG. 12 for clarity. The flexographic application module 750* includes plate cylinder 830, which cooperates with an impression cylinder 840. The plate cylinder 830 carries a suitable flexograophic printing plate (with relief portions corresponding in shape and position to the area on the sheets S where the layer of curable material is to be applied) which cooperates with an anilox roller 830a equipped with an associated supply chamber where the curable material to be applied is supplied.

Processing of sheets S by printing press 5000 of FIG. 12 is carried out in the same way as on printing press 4000 of FIG. 11, with the only difference that the layer of curable material applied for forming the light control layer is applied by flexographic printing rather than screen printing. Once the light control layer and effect-generating layer have been applied, transfer roller 950 transfers the sheets S towards inspection module (not shown), which may be located as described with reference to FIG. 11.

FIG. 13 shows an alternative embodiment for applying the curable material for forming the light control layer within a further example printing press 6000. In this example, the curable material is applied directly onto the embossing form, e.g. onto the surface of the casting cylinder 8500 before the substrate, i.e. sheets S are arranged on it. In this case the application unit 750** is located at the embossing tool 8500, preferably at the circumference of the embossing cylinder 8500, especially in a peripheral section between take over and delivery of the sheets S. The application unit 750** can be designed as a screen printing unit or flexographic printing unit as above but, preferably, it is designed similar to an inking apparatus with at least a fountain roller receiving the curable material from a reservoir and directly or through one or more further rollers transfer the material onto the surface of the embossing cylinder 8500. The further printing section has been omitted from FIG. 13 for clarity. Once the light control layer and effect-generating layer have been applied, transfer roller 950 transfers the sheets S towards inspection module (not shown), which may be located as described with reference to FIG. 11.

It will be understood that the above examples of printing presses are exemplary only, and inspection according to the present invention may be used in or for any machine or press suitable for manufacturing security documents or articles comprising a transparent light control layer. In this way, the present invention allows for improved quality control inspection of light control layers during the manufacturing of security devices on security documents and security articles. In particular, the present invention has particular benefit in quality control during web-based and sheet-based manufacturing processes.

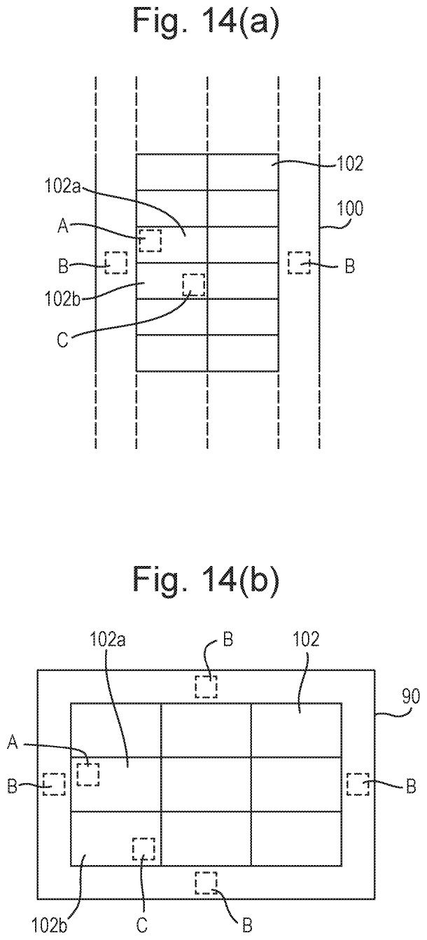

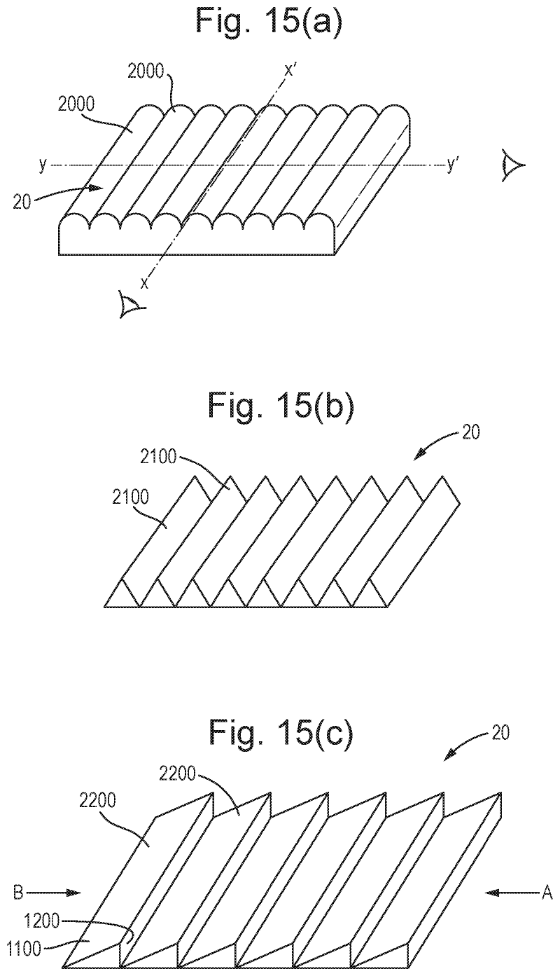

In the examples discussed above, the light control layer that is inspected by the inspection module is an integral part of a security device of the security article (e.g. security thread or foil) or security document (e.g. banknote) being manufactured. However, in alternative examples, the light control layer that is inspected may be separate to the light control layer for the final security device, as will be explained with reference to FIGS. 14(a) and 14(b).

FIG. 14(a) shows a portion of a transparent web substrate 100 and illustrates various positions where a light control layer may be applied for inspection.

Here, the web 100 comprises a plurality of banknotes 102. The final banknotes 102 are designed to have a security device (comprising a light control layer) at a top left hand corner, as shown at A on banknote 102a. During manufacture, the light control layer formed at position A may then be subsequently inspected.

In some examples, a light control layer having the same structure as that of the final security device may be formed at a location laterally separate to the banknotes, for example on the edges of the web as illustrated at B. Such “test” light control layers may then be cut off and discarded when the web is cut into sheets or single banknotes.

As a further example, a “test” light control layer having a structure specifically designed to infer the quality of the casting process may be formed. Such a test light control layer would typically have a different structure to that of the final security device, although be formed by the same printing press. In this case the “test” light control layer may be applied laterally separate to the banknotes (e.g. position B) and subsequently discarded; or may be formed on the banknote itself laterally separate to the security device (e.g. positon C on banknote 102b) so as not to interfere with the optical effect exhibited by the security device. When formed on the banknote itself, the light control layer would be designed to not be noticeable to the end user.

Such a “test” light control layer having a different structure to that of the final security device may be used in two main circumstances. The first is when the light control layer of the final security device is complex in form — for example it may have multiple orientations, pitch and geometry meaning that the corresponding light pattern is complex (e.g. multiple spots in a complex arrangement) and difficult to compare against reference data at the speed of the web or sheet processing. In such a circumstance the “test” light control layer may have a simpler form (e.g. a single orientation) that allows for easier comparison of the inspection light pattern with the reference data. If the “test” light control layer meets the predetermined quality threshold, then it can be inferred that the light control layer of the final security device—formed by the same application and casting process—also meets the predetermined quality threshold. The “test” light control layer and the light control layer of the final security device are typically formed using the same casting tool, with the surface relief of the casting tool having laterally spaced regions for the test light control layer and the light control layer of the security devices.

A second circumstance is where it is desired to infer more information about the casting process than is possible from the light pattern obtained from the light control layer of the final security device. For example, if the light control layer of the final security device comprises a one dimensional array of microprisms, then the inspection light pattern will be in the form of a single line of spots (as in FIGS. 5(a) and 5(b)). This may be sufficient in most situations. However, if it is desired to infer the quality of the casting in two directions (e.g. machine direction and a cross direction orthogonal to the machine direction), then the “test” light control layer may be a two dimensional (e.g. more complex) structure than the light control layer of security device itself.

FIG. 14(b) illustrates possible positions for inspection of a light control layer on a sheet 90 of banknotes 102. In the same manner as described for FIG. 11(a), the final security device is located at the top left hand corner of each banknote (position A on banknote 102a). A light control layer applied to position A may be inspected. A “test” light control layer having the same structure as the final security device may be applied to the sheet laterally separate to the banknotes themselves (e.g. to the sides, top and/or bottom of the sheet as shown at B) and inspected, thereby inferring the quality of the final security device. Such light control layers may be discarded when the sheets are cut into individual banknotes. As a further example, an optimised light control layer structure for inference of the quality of the casting process may be applied either to the top, bottom and/or side edges of the sheet (position B) or on the banknote itself (position C).

It is to be noted that in all examples described in FIGS. 14(a) and 14(b), a light control layer will be formed at positon A as this is the location of the final security device.

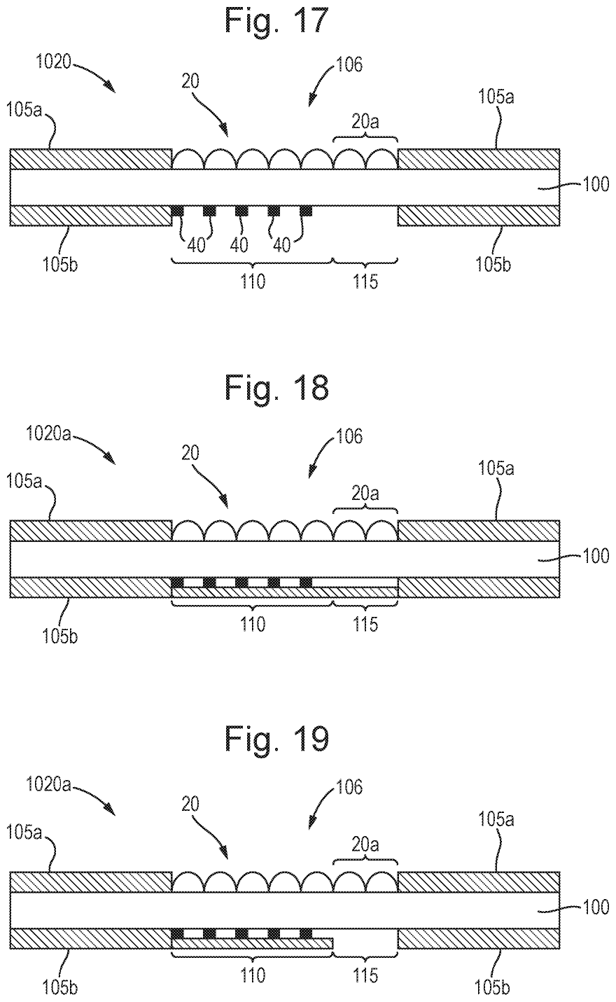

FIG. 17 illustrates an example of a security document carrying a light control layer that may be inspected using the present invention, e.g. for quality control purposes during manufacture of the security document. In this example, the security document comprises a test light control layer 20a, as will be explained below.

FIG. 17 schematically illustrates a cross-sectional view of a security document 1020 in the form of a banknote, having a security device 110 integrated therein. The banknote 1020 comprises a transparent polymer substrate 100 (such as biaxially-oriented polypropylene (BOPP)). Opacifying layers 105a, 105b are applied to both surfaces of the substrate 100 so as to define a window region 106 within which the security device 110 and test light control layer are located. The banknote 1020 shown in FIG. 17 may be manufactured using a web-based or sheet-based printing press as described above with reference to FIGS. 8-13 and 16 for example.

Within the window region 106, the security device 110 comprises a light control layer 20 in the form of a microlens array provided on one surface of the substrate 100, and an array of image elements 40 provided (e.g. printed) on the opposing surface and located substantially within the focal plane of the lens array. The microlenses and image element array cooperate with each other to generate an optically variable lenticular or moire effect to a viewer, as is known in the art. Security devices 110 exhibiting alternative optically variable effects may be used. For example, a colour shifting layer may be used in place of the microimage element array, and the light control layer may comprise an array of refractive microprisms rather than the microlenses depicted in FIG. 17.

Laterally offset from the image element array is an inspection region 115 that is absent of any effect-generating elements. The inspection region 115 is located in a pre-defined region on the banknote, typically laterally adjacent the image element array (or other effect-generating region or layer where used). In other words, in this example the inspection region 115 is absent of any image elements 40. The microlens array 20 laterally extends so as to overlap with both the array of image elements 40 and the inspection region 115. The microlenses overlapping with the inspection region 115 form the test light control layer 20a (or test region of the light control layer 20). Typically, the test light control layer is formed in the same step as the light control layer of the security device 110.

When inspecting the light control layer 20 of the banknote (typically during manufacture), the inspection light pattern may be obtained by directing a laser beam towards the location of the test light control layer 20a. Consequently, the beam passes through the inspection region 115 to form an inspection light pattern with no interference from the image element array (although, as has been outline above, an inspection light pattern may still be obtained if the beam does pass through an effect generating layer). The quality of the light control layer of the security device 110 may be inferred from the result of the inspection of the test light control layer.

As has been discussed above, a laser beam used for inspection typically has a diameter in the range of 50 microns and 10 millimetres, preferably between 500 microns and 5 millimetres. Thus, the inspection region 115 (and test light control layer) typically has a dimension of at least 50 microns, preferably at least 500 microns. To provide a large target for the inspection beam during inspection of the light control layer, a preferred dimension of the inspection region 115 (and test light control layer) is greater than 3 mm and less than 10 mm, preferably between 3.5 mm and 5 mm.

In FIG. 17, window region 106 is a “full” window region, in that both opacifying layers 105a, 105b are omitted in register such that the light control layer 20 may be viewed from both sides of the banknote. Hence, the optical effect of the security device may be viewed in both reflection and transmission. FIG. 18 illustrates an alternative construction of the banknote 1020a, where the window 106 is in the form of a “half” window region. Here, the opacifying layer 105b is present across the window region 106, and the optical effect of the security device is visible in reflection. In such constructions, the inspection light pattern obtained from test light control layer 20a may be generated and analysed in reflection.

FIG. 19 illustrates a further alternative construction of the banknote 1020b, wherein the opacifying layer 105b is omitted across the inspection region 115 but extends across the image element array. Thus, the security device 100 may be visible in reflection, but the inspection light pattern obtained when inspecting the test light control layer 20a may be generated in transmission. In a yet further alternative construction, the opacifying layer 105b may be present in the inspection region and omitted across the effect generating region.

Although the examples of FIGS. 17 to 19 have been described in relation to a security document in the form of a banknote, it will be appreciated that such a test light control layer and inspection region may be provided on or integrated within other types of security document or security article.

1. A method of inspecting a substantially transparent light control layer for an optically variable security device, the substantially transparent light control layer comprising a surface relief defined by an array of substantially transparent refractive microstructures, the method comprising:
directing a beam of substantially collimated light towards a first region that is expected to contain the surface relief of the light control layer so as to generate an inspection light pattern;
providing reference data that is indicative of a light control layer that meets a predetermined quality threshold;
comparing the inspection light pattern with the reference data; and
determining whether the light control layer meets the predetermined quality threshold based on the comparison.

2. The method of claim 1, wherein the light control layer is located on a web or a sheet, and the method further comprises
conveying the web or sheet in a machine direction, wherein the beam of substantially collimated light is directed towards the first region as the web or sheet is conveyed in the machine direction.

3. The method of claim 1, wherein the light control layer is part of a security device.

4. The method of claim 3 wherein the method comprises determining the authenticity of the security device based on whether the light control layer meets the predetermined quality threshold.

5. The method of claim 1, wherein the light control layer does not form part of a security device.

6-8. (canceled)

9. The method of claim 1 wherein the reference data comprises a reference value of a predetermined metric and the comparing step comprises
detecting an inspection value of the predetermined metric from the inspection light pattern, and
comparing the inspection value with the reference value.

10. The method of claim 9, wherein the predetermined metric is any of:
(i) a number of elements in the inspection light pattern;
(ii) a resolution of the inspection light pattern;
(iii) an intensity of the inspection light pattern;
(iv) an orientation of the inspection light pattern;
(v) a pitch of the inspection light pattern.

11-12. (canceled)

13. The method of claim 1, wherein the reference data is in the form of a reference light pattern.

14. The method of claim 12, wherein the reference light pattern is obtained by directing a beam of substantially collimated light towards a reference light control layer that is known to meet the predetermined quality threshold.

15. The method of claim 1, wherein the inspection light pattern is in the form of a spot pattern.

16. The method of claim 2, wherein if it is determined that the light control layer does not meet the predetermined quality threshold, the method further comprises at least one of:
marking the web or sheet to indicate that the light control layer did not meet the predetermined quality threshold;
noting the location on the web or sheet of the light control layer that did not meet the predetermined quality threshold; and
stopping conveying the web or sheet along the machine direction.

17-18. (canceled)

19. The method of claim 1, wherein the beam of substantially collimated light is provided by a laser source.

20. The method of claim 1, wherein the beam has a diameter at the first region of between 50 microns and 10 millimetres, preferably between 500 microns and 5 millimetres.

21. (canceled)

22. The method of claim 1, wherein the light control layer is formed from a transparent curable material.

23. (canceled)

24. The method of claim 1, wherein the array of refractive microstructures comprises an array of focussing elements, or wherein the array of refractive microstructures comprises an array of microprisms.

25. (canceled)

26. The method of claim 1, wherein the beam of substantially collimated light has a diameter at the first region that is greater than a pitch of the surface relief.

27. The method of claim 1, wherein the method is performed in a web-based or sheet-based manufacturing process for manufacturing security documents or security articles having security devices located thereon or therein, wherein the security devices comprise a transparent light control layer.

28. An inspection apparatus for inspecting a substantially transparent light control layer for an optically variable security device, the substantially transparent light control layer comprising a surface relief defined by an array of substantially transparent refractive microstructures, the inspection apparatus comprising:
a light source configured to direct a beam of substantially collimated light towards a first region that is expected to contain the surface relief of the light control layer so as to generate an inspection light pattern;
an optical sensor configured to record the inspection light pattern; and
a comparison module configured to compare the recording of the inspection light pattern with reference data that is indicative of a light control layer that meets a predetermined quality threshold, and to determine whether the light control layer meets the predetermined quality threshold based on the comparison.

29. The apparatus of claim 28, wherein the light control layer is located on a web or a sheet, and wherein the inspection apparatus is configured to receive the web or sheet on which the light control layer is located, and convey the web or sheet through the apparatus in a machine direction.

30. The apparatus of claim 29, further comprising a marking module configured to mark the web or sheet if it is determined by the comparison module that the light control layer did not meet the predetermined quality threshold.

31. (canceled)

32. The apparatus of claim 28, wherein the light source is a laser source.

33-38. (canceled)

39. A web-based or sheet-based press for manufacturing security articles or security documents, comprising an inspection apparatus adapted to perform the method of claim 1.

40. A security document or security article comprising:
a transparent substrate carrying opacifying layers on opposing surfaces thereof so as to define a window region; wherein within the window region the document or article comprises:
an effect generating region comprising one or more effect generating elements;
an inspection region laterally offset from the effect generating region, wherein the inspection region is free of any effect generating elements; and
a substantially transparent light control layer comprising a surface relief defined by an array of substantially transparent refractive microstructures, the light control layer overlapping with both the effect generating region and the inspection region, and wherein the substantially transparent light control later cooperates with the effect generating region to exhibit an optically variable effect.

41-43. (canceled)
